(19) United States
(12) Patent Application Publication
(10) Pub. No.: US 2008/0063081 A1
(43) Pub. Date: Mar. 13, 2008

(54) Apparatus, method and program for encoding and/or decoding moving picture

(76) Inventors: Masayasu Iguchi, Hyogo (JP); Jun Takahashi, Kyoto (JP)

Correspondence Address: MCDERMOTT WILL & EMERY LLP, 600 13TH STREET, NW, WASHINGTON, DC, 20005-3096, US

(21) Appl. No.: 11/826,244

(22) Filed: Jul. 13, 2007

(30) Foreign Application Priority Data
Sep. 12, 2006 (JP) 2006-246485

(51) Int. Cl. H04N 7/26

(52) U.S. Cl. 375/240.23; 375/240.25; 375/E07.027

(57) ABSTRACT

In a moving picture decoding apparatus compliant with a coding standard, such as CABAC of H.264 and the like, for coding of a stream including arithmetic coded data, a first type variable length decoding section performs first variable length decoding including arithmetic decoding to input stream data to generate first stream data beforehand. The first recording control section records a key frame which is selected from the first stream data not needing arithmetic decoding and is necessary in special playback in a first recording region. In decoding, the recorded key frame not needing arithmetic decoding is used, a decoding time is reduced. Accordingly, even when a moving picture stream for special playback such as multiple-fold speed playback is performed, reverse playback and the like, as smooth special playback as known special playback of a moving picture signal which does not include arithmetic coded data can be achieved.

### CROSS-REFERENCE TO RELATED APPLICATION

This non-provisional application claims priority under 35 U.S.C. § 119(a) on Patent Application No. 2006-246485 filed in Japan on Sep. 12, 2006, the entire contents of which are hereby incorporated by reference.

### BACKGROUND OF THE INVENTION

The present invention relates to an encoding/decoding apparatus for smoothly performing special playback such as fast-forwarding and reverse playback for a moving picture stream using a variable length coding tool such as arithmetic coding or the like.

Recently, with the arrival of the multimedia age where audio, video and other pixel values are integrally handled, known information media such as newspaper, magazines, TV, radio, telephone and the like, i.e., means for conveying information to people has been taken up as an object of multimedia. In general, multimedia is something represented by associating not only characters but also graphics, sounds, and specifically pictures and the like at the same time. To handle the above-described known information media as an object of multimedia, it is necessary to convert information into a digital format.

When an information amount contained in each of the above-described information media is estimated as a digital information amount, an information amount per character is 1-2 bytes. In contrast, an information amount of audio information (phone quality) is 64 Kbit or more per second and, furthermore, an information amount of a moving picture (current TV reception quality) is 100 Mbits or more per second. Therefore, it is not practical to handle such an enormous amount of information in the digital format as it is through the above-described information media. For example, video phone has been already put into practical use via Integrated Services Digital Network (ISDN) having a transmission rate of 64 Kbit/s to 1.5 Mbit/s. However, it is not possible to transmit a video picture on the TV screen or from a camera as it is via ISDN.

Accordingly, information compression techniques are required. For example, for video phones, moving picture compression techniques compliant with the H.261 and H.263 standards recommended by ITU-T (International Telecommunication Union Telecommunication Standardization Sector) are used. Moreover, according to information compression techniques compliant with the MPEG-1 standard, picture information can be stored with audio information in a regular music CD (compact disc).

MPEG (Moving Picture Experts Group) is an international standard for compression of moving picture signals standardized by ISO/IEC (International Standardization Organization/International Electrotechnical Commission). The MPEG-1 is a standard for compressing a moving picture signal down to 1.5 Mbps, i.e., compressing TV signal information down to about 1/100. In the MPEG-1 standard, medium level quality, which could be achieved at a transmission rate of about 1.5 Mbps, has been targeted. Then, in MPEG-2 which has been standardized to meet requirements for higher picture quality, a moving signal is transmitted at a transmission rate of 2-15 Mbps, to achieve TV broadcasting quality. Moreover, in the present circumstances, the working group (ISO/IEC JTC1/SC29/WG11) which has been worked for standardization of MPEG-1 and MPEG-2 has achieved a higher compression rate than those of MPEG-1 and MPEG-2 and, furthermore, encoding, decoding and operation per an object. Thus, MPEG-4 which can realize a new function necessary in the multimedia age has been standardized. The standardization of MPEG-4 was initiated aiming to standardize low bit rate coding method. However, the aim has been expanded to include a more versatile encoding for pictures including interlaced pictures at high bit rate.

Furthermore, in 2003, ISO/IEC and ITU-T jointly worked to standardize MPEG-4AVC and H.264 as picture coding systems with higher compression rate. The H.264 standard has been expanded to include a modified specification compliant with High Profile, which is suitable for HD (High Definition) pictures. Like MPEG-2 and MPEG-4, applications compliant with the H.264 standard have been widely spread to include digital broadcasting, DVD (Digital Versatile Disk) players/recorders, hard disk players/recorders, camcorders, video telephones and the like.

In general, in coding a moving picture, redundancy both in temporal and spatial directions is eliminated, thereby compressing the amount of information. In inter-picture predication coding for eliminating temporal redundancy, motion detection and generation of a prediction picture are performed block by block with reference to a picture in a forward or backward direction, and then coding is performed to a difference value between an obtained prediction picture and a picture to be coded. Herein, “picture” is a term for a single image. A “picture” means a frame when the term is used for a progressive picture and means a frame or a field when the term is used for an interlaced picture. An “interlaced picture” is a picture in which a single frame includes two fields at different times. In coding and decoding of an interlaced picture, a single frame can be processed as a frame or as two fields, or each block in a frame can be processed as a frame structure or a field structure.

A picture to which intra-picture prediction coding is performed without a reference picture is called “I-picture”. A picture to which inter-picture prediction coding is performed with only a single reference picture is called “P-picture”. A picture to which inter-picture prediction coding is performed with reference to two reference pictures at the same time is called “B-picture”. As for B-pictures, two pictures as an arbitrary combination of pictures from forward or backward directions in a display time can be referred. A reference picture can be specified for each macroblock which is a basic unit for coding, and a reference picture to be described first in a coded bit stream and a reference picture to be described later in the coded bit stream are distinguished as a first reference picture and a second reference picture, respectively. Note that as a condition for coding the above-described pictures, pictures to be referred to have to be pictures which have been already coded.

Motion compensation inter-picture prediction coding is used to code a P-picture or a B picture. Motion compensation inter-picture prediction coding is a coding system in which motion compensation is applied to inter-picture prediction coding. Motion compensation is not a technique in which prediction is performed simply from a pixel value of a reference frame but a technique in which a motion amount (hereafter referred to as a “motion vector”) of each part within a picture is detected and prediction is performed in consideration of the motion amount, so that prediction accuracy is improved and the amount of data is reduced. For example, a motion vector of a picture to be coded is detected and then a prediction value obtained from a shift corresponding to the motion vector and a prediction residual from the picture to be coded are coded, thereby reducing the amount of data. In this technique, because information for a motion vector is needed in decoding, the motion vector is also coded and then recorded or transferred.

A motion vector is detected for each macroblock. Specifically, a macroblock in a picture to be coded is fixed and a macroblock in a reference picture is moved within a search range. Then, a location of a reference block which resembles a basic block the most is found to detect a motion vector.

FIG. 15 is a block diagram illustrating a configuration of a known moving picture encoding apparatus. The moving picture encoding apparatus includes an intra-picture prediction evaluator IE, an intra-picture predictor IPD, a motion estimator ME, a multi-frame memory FrmMem, a subtractor Sub1, a subtractor Sub2, a motion compensator MC, an encoder Enc, an adder Add1, a motion vector memory MVMem and a motion vector predictor MVPred.

In intra-picture prediction of an I-picture or the like, the intra-picture prediction evaluator IE compares an intra-picture prediction evaluation pixel IEpel output from the multi-frame memory FrmMem to a picture signal Vin and outputs an intra-picture prediction direction IDir. The intra-picture prediction direction IDir is an identification signal for specifying a reference picture to be referred.

The multi-frame memory FrmMem outputs a pixel indicated by the intra-picture prediction direction IDir as an intra-picture prediction reference pixel IPDPel1, the intra-picture predictor IPD generates a reference pixel according to the intra-picture prediction direction IDir and outputs an intra-picture prediction reference pixel IPDpel2. The subtractor Sub1 subtracts the intra-picture prediction reference pixel IPDpel2 from the picture signal Vin and outputs a picture prediction error DifPel.

In intra-picture prediction of a P-picture or a B-picture, the motion estimator ME compares a motion detection reference pixel MEpel output from the multi-frame memory FrmMem to a picture signal Vin and outputs a motion vector MV and a reference frame number RefNo. The reference frame number RefNo is an identification signal for specifying a reference picture which is selected from a plurality of reference pictures and is to be referred to for a picture to be compressed. The motion vector MV is temporarily stored in the motion vector memory MVMem, is output as a neighbor motion vector and then is used as a neighbor motion vector PrevMV to be referred to for predicting a prediction motion vector PredMV in a motion vector predictor MVPred. The subtractor Sub2 subtracts the prediction motion vector PredMV from the motion vector MV and a difference between the prediction motion vector PredMV and the motion vector MV is output as a motion vector prediction difference DifMV.

The multi-frame memory FrmMem outputs a pixel indicated by the reference frame number RefNo and the motion vector MV as a motion compensation reference pixel MCPel1, and the motion compensator MC generates a reference pixel with decimal pixel accuracy and outputs a reference picture pixel MCpel2. The subtractor Sub1 subtracts the reference picture pixel MCPel2 from the picture signal Vin and outputs the picture prediction error DifPel.

The encoder Enc performs variable length coding to the picture prediction error DifPel, the intra-picture prediction direction IDir, the motion vector prediction difference DifNIV and the reference frame number RefNo and outputs a coded signal Str. A decoded picture prediction error RecDifPel which is a result of decoding of a picture prediction error is output at the same time as encoding. The decoded picture prediction error RecDifPel is obtained by superimposing a coded error on the picture prediction error DifPel and matches with an inter-picture prediction error obtained by decoding the coded signal Str using an inter-picture prediction decoding apparatus.

The adder Add1 adds the decoded picture prediction error RecDifPel to the reference picture pixel MCpel2 and stores a result of the addition as a decoded picture RecPel in the multi-frame memory FrmMem. However, in order to effectively utilize a capacity of the multi-frame memory FrmMem, a region of a picture stored in the multi-frame memory FrmMem is released if it is not necessary, or the decoded picture RecPel of a picture which does not have to be stored in the multi-frame memory FrmMem is not stored in the multi-frame memory FrmMem.

FIG. 16 is a block diagram illustrating a configuration of a known moving picture decoding apparatus. In FIG. 16, each member also shown in FIG. 15 is identified by the same reference numeral and therefore the description thereof will be omitted.

The known moving picture decoding apparatus of FIG. 16 decodes a coded signal Str coded by the known moving picture prediction coding apparatus of FIG. 15 and outputs a decoded picture signal Vout. The moving picture decoding apparatus includes a multi-frame memory FrmMem, an intra-picture predictor IPD, a motion compensator MC, an adder Add1, an adder Add2, a motion vector memory MVMem, a motion vector predictor MVPred and a decoder Dec.

The decoder Dec decodes the coded signal Str and outputs a decoded picture prediction error RecDifPel, an intra-picture prediction direction IDir, a motion vector prediction difference DifMV and a reference frame number RefNo. The adder Add2 adds a prediction motion vector PredMV output from a motion vector predictor MVPred and a motion vector prediction difference DifMV and decodes a motion vector MV.

In intra-picture prediction, the multi-frame memory FrmMem outputs a pixel indicated by the intra-picture prediction direction IDir as an intra-picture prediction pixel IPDpel1, and the intra-picture predictor IPD generates a reference pixel according to the intra-picture prediction direction IDir and outputs an intra-picture prediction reference pixel IPDpel2. The adder Add1 adds the decoded picture prediction error RecDifPel to the intra-picture prediction reference pixel IPDpel2 and stores a result of the addition as a decoded picture RecPel in the multi-frame memory FrmMem.

On the other hand, in inter-picture prediction, the multi-frame memory FrmMem outputs a pixel indicated by the reference frame number RefNo and the motion vector MV as a motion compensation reference pixel MCpel1 and the motion compensator MC generates a reference pixel with decimal pixel accuracy and outputs the reference picture pixel MCpel2. The adder Add1 adds the decoded picture prediction error RecDifPel to the reference picture pixel MCpel2 and stores a result of the addition as the decoded picture RecPel in the multi-frame memory FrmMem.

To effectively utilize a capacity of the multi-frame memory FrmMem, a region of a picture stored in the multi-frame memory FrmMem is released if it is not necessary, and the decoded picture RecPel of a picture which does not have to be stored in the multi-frame memory FrmMem is not stored in the multi-frame memory FrmMem. In the above-described manner, the decoded picture signal Vout, i.e., the decoded picture RecPel can be correctly decoded from the coded signal Str.

Next, a method for performing special playback such as multiple-fold speed playback and reverse playback of a moving picture will be described with reference to FIGS. 17A through FIG. 17C and FIGS. 18A through 18E. FIGS. 17A through FIG. 17C are schematic views showing how multiple-fold speed playback is performed in a known manner. In FIG. 17A, P1701 is a timing chart showing timing for decoding in normal playback of 1 GOP (Group Of Pictures). FIG. 17A shows an example where 1 GOP consists of 15 frames and an interval between an I- or P-picture and a subsequent P-picture is set to be 3. For simplification, a time required for decoding of each picture is assumed to be the same. P1720 is a timing chart showing timing for displaying a picture. A B-picture is formed, in general, with reference to pictures from the forward and backward directions and thus the order of decoding timing is different from the order of display timing.

When multiple-fold speed playback is performed, a method in which decoding is actually performed at predetermined multiple-fold speed and then display is performed at a multiple-fold speed, a method in which several pictures are skipped when display is performed or various methods can be used. However, in the above-described methods, processing performance of a moving picture decoding apparatus has to be improved to a level where playback can be performed at an expected multiple-fold speed, so that circuit costs are increased and power consumption is increased. Therefore, there are cases where the implementation methods of FIGS. 17B and 17C are used. P1703 of FIG. 17B is a timing chart showing timing for decoding a B-picture. In this case, a decoding time is reduced by performing IP playback which does not require decoding of two B-pictures existing between P-pictures and picture display is performed so as not display B-pictures in the same manner. Thus, three-fold speed playback is realized.

In the same manner, P1704 of FIG. 17C is a timing chart showing that by decoding only an I-picture, 15-fold speed playback can be realized although smooth picture display can not be expected.

Next, the case where reverse playback of a stream having a GOP structure of FIG. 17 will be considered. When a capacity of the multi-frame memory FrmMem is limited to about a buffer size used in normal decoding, a time-consuming complex processing is required for reverse playback. FIG. 18 is a schematic view showing how reverse playback is performed in a known manner. Reverse playback in which pictures are displayed in the order of P14, B13, B12, P11, B10, B9, P8, B7, B6, P5, B4, P3, I2, B1 and B0 is shown in FIGS. 18A through 18E in chronological order.

FIG. 18A shows decoding for displaying three pictures P14, B13 and B12 shown in a timing chart P1802. As shown in a timing chart P1801, to decode the pictures B13 and B12, pictures P11 and P14 are needed, and thus pictures I2, P5, P8, P11 and P14 have to be decoded in this order.

In the same manner, FIG. 18B shows decoding for displaying three pictures P11, B10 and B9 shown in a timing chart P1804. As shown in a timing chart P1803, to decode the pictures B10 and B9, pictures P8 and P11 are needed, and thus pictures I2, P5, P8 and P11 have to be decoded in this order. FIG. 18C shows decoding for displaying three pictures P8, B7 and B6 shown in a timing chart P1806. As show in a timing chart P1805, to decode the pictures B7 and B6, pictures P5 and P8 are needed, and thus pictures I2, P5 and P8 have to be decoded in this order. FIG. 18D shows decoding for displaying three pictures P5, B4 and B3 shown in a timing chart P1808. As shown in a timing chart P1807, to decode the pictures B4 and B3, pictures I2 and P5 are needed, and thus pictures I2 and P5 have to be decoded in this order.

Finally, FIG. 18E shows decoding for displaying three pictures I2, B1 and B0 shown in a timing chart P1810. Note that in actual situation, besides decoding of I2, B0 and B1 shown in a timing chart P1809, IP playback of the previous GOP have to be performed to generate a P-picture immediately before the picture I2.

As has been described, by performing the decoding of FIGS. 18A through 18E, reverse playback of a moving picture is realized when the capacity of the multi-frame memory FrmMem is limited. Note that the same key frame has to be decoded for a number of times. Therefore, in displaying all frames, signal processing performance about twice as high as signal processing performance required for normal playback is needed. The above-described known techniques are described, for example, in Japanese Laid-Open Publication No. 2004-135251 and ITU-T Recommendation H.264, “SERIES H: AUDIOVISUAL AND MULTIMEDIA SYSTEMS Infrastructure of audiovisual services—Coding of moving video: Advanced video coding for generic audiovisual services,” March 2005.

By the way, in H.264, as a variable length coding tool used for the encoder Enc of FIG. 15 and the decoder Dec of FIG. 16, arithmetic coding (CABAC) is set. When a variable length decoding using an arithmetic coding is performed, as a characteristic of the decoding, sequential encoding or decoding is necessary per bits constituting a syntax (i.e., intra-picture prediction direction IDir, picture prediction error DifPel, motion vector prediction difference DifMV and reference frame number RefNo in FIG. 15 and FIG. 16).

In sequential processing per bits, a plurality of bits (for example, a plurality of bits, constituting the motion vector prediction difference DifMV or the like, i.e., a syntax) can not be processed at one time, and it is difficult to improve processing performance. Therefore, a processing time in proportion to a bit amount allocated to each picture is required.

<Problems in Multiple-Fold Speed Playback>

FIGS. 19A through 19C are schematic views showing problems in multiple-fold speed playback of a stream including arithmetic coded data. Conventionally, in MPEG or the like, the amount of allocated bits is adjusted depending on a type of picture. Specifically, by allocating a large coding amount to a key frame such as an I-picture, a P-picture or the like to be referred to, particularly, to an I-picture and reducing a coding amount of a B picture instead, the whole picture quality is improved. FIG. 19A shows timing for decoding in normal playback when a bit amount is set for I, P and B pictures, for example, so as to hold the ratio of 5:3:1. In FIG. 19A, P1901 is a timing chart showing timing of first type variable length decoding including arithmetic decoding, P1902 is a timing chart showing timing of second type variable length decoding which does not include arithmetic decoding after the timing P1901, and P1903 is a timing chart showing timing of displaying a picture as a result of decoding. The first type variable length decoding is sequential decoding per several bits and thus requires a decoding time substantially in proportion to an allocation bit amount. The second type variable length decoding can be performed per syntax including a plurality of bits and thus decoding can be performed without being proportional to a bit amount. For simplification, timing of the second type variable length decoding is set under the assumption that any picture can be processed at a certain time.

For simplification, in description given here, it is assumed that the first type variable length decoding is completed within 1 GOP time. However, in actual situations, there are cases where a processing time longer than 1 GOP is required for the first type variable length decoding.

Next, FIG. 19B shows processing timing to aim three-fold speed playback by employing IP playback in which B-pictures are not decoded in the same manner as in FIG. 17B. However, when IP playback is performed, as shown in a timing chart P1904, only decoding of B-pictures is not executed. Since a processing time of the first type variable length decoding for B-pictures is short, it is estimated that only about 1.6 (=(5+3×4+1×10)/(5+3×4))-fold speed playback performance can be achieved. As a result, as shown in a timing chart P1905, in the second type variable length decoding, completion of the first type variable length decoding including arithmetic coding of I and P pictures has to be waited for. Accordingly, a non-processing time equal to the waiting time is generated, so that whole processing efficiency is reduced.

In the same manner, FIG. 19C shows processing timing to aim 15-fold speed playback by employing playback of only I-pictures in which B-pictures are not decoded in the same manner as in FIG. 17C. However, when only I-pictures are played back, as shown in a timing chart P1906, decoding of B-pictures and P-pictures is not performed and a processing time of the first type variable length decoding for B- and P- pictures is short. Therefore, only about 5.4(=(5+3×4+1×10)/5)-fold speed playback performance can be realized. As a result, as shown in the timing chart of P1906, in the second type variable length coding, a non-processing time is further generated in the same manner as described above, so that whole processing efficiency is further reduced.

Accordingly, when a moving picture stream is decoded for special playback within a coding standard using a variable length coding tool employing arithmetic coding such as CABAC of H.264, the performance of a decoding apparatus has to be markedly increased. Otherwise, even if I- and P- picture playback or playback of only I-pictures is performed, the same level of performance as special playback performance by known technique which does not employ arithmetic coding can not be achieved.

<Problems in Reverse Playback>

Next, problems which arise in performing reverse playback will be described with reference to FIGS. 20A through 20B. FIGS. 20A through 20B are schematic views showing problems in reverse playback of a stream including arithmetic coded data. FIG. 20A shows timing of known reverse playback. FIG. 20B shows timing of the first type variable length decoding including arithmetic coding.

In FIG. 20A, P2001 through P2005 are timing charts obtained by removing pictures which are not actually used for decoding from the timing charts shown in FIGS. 18A through 18E. The timing charts P2001 through P2005 are connected in the ascending order from P2001 to P2005. If a larger number of frames can be stored in the multi-frame memory FrmMem, compared to the case of normal decoding, it is not necessary to repeatedly decode the same frame. However, the number of frames is usually limited, and thus the same key frame has to be decoded for a number of times.

As shown in FIG. 20A, where the GOP size is 15 and an interval between an I or P picture and a subsequent P-picture is three pictures, 30 frames have to be decoded in reverse playback. That is, with processing power performing double fold (30/15) playback, smooth picture display can be achieved.

FIG. 20B shows timing of the first type variable length decoding including arithmetic coding. The processing order is the same as that in the known technique shown in FIG. 20A. However, a large amount of bits is allocated to a key frame needing a number of decoding and thus a longer time than a processing time of the known reverse playback is required for arithmetic decoding of the key frame. Accordingly, the whole processing time is increased. If the ratio for bit allocation is set to be the ratio of I:P:B=5:3:1, about three (=(5×6+3×15+1×10)/(5×1+3×4+1×10))-fold arithmetic decoding power is required. However, as described above, sequential decoding per several bits has to be performed and thus it is difficult to simply improve processing power.

### SUMMARY OF THE INVENTION

It is therefore an object of the present invention to achieve as smooth special playback of even a moving picture signal including variable length coded data using arithmetic coding as known special playback of a moving picture signal which does not include variable length coded data using arithmetic coding by reducing processing time for decoding the moving picture signal.

To achieve the above-described object, according to the present invention, in encoding a moving picture signal including variable length coded data using arithmetic coding, variable length coding which does not includes arithmetic coding is performed to the moving picture signal and then variable length coding including arithmetic coding is performed. Thus, predetermined ones of signals before arithmetic coding is performed thereto are recorded beforehand and, in subsequent encoding, those signals recorded before arithmetic coding is performed thereto are utilized. Moreover, in decoding of a moving picture signal including variable length coded data using arithmetic coding, first, variable length decoding including arithmetic decoding is performed and then a variable length decoding which does not include arithmetic decoding is performed. Thus, for predetermined ones of signals, arithmetic coded signals are generated and recorded beforehand and in subsequent actual decoding, the arithmetic coded signals are utilized. Accordingly, sequential decoding per several bits in arithmetic decoding becomes not necessary and a decoding time is reduced.

Specifically, a moving picture decoding apparatus according to the present invention is a moving picture decoding apparatus for decoding a moving picture signal including variable length coded data using arithmetic coding and is characterized by including: a first variable length decoding section for performing first type variable length decoding including arithmetic decoding to input stream data to generate first type stream data; a second type variable length decoding section for performing second type variable length decoding which does not include arithmetic decoding to the first type stream data generated by the first type variable length decoding section to generate output data; and a first recording control section for selecting only specific data from the first type stream data generated by the first type variable length decoding section to record the specific data in a first recording region.

In one embodiment of the present invention, the moving picture decoding apparatus is characterized in that the apparatus further includes a selecting section for selecting one of the specific data generated by the first type variable length decoding section and recorded in the first recording region and the first type stream data other than the specific data, and the second type variable length decoding section receives, according to the selecting section, the specific data selected out of the first type stream data from the first recording region and the first type stream data other than the specific data from the first type variable length decoding section.

In one embodiment of the present invention, the moving picture decoding apparatus is characterized in that the first recording control section selects data to be used in special playback as the specific data from the first type stream data and records the specific data in the first recording region.

In one embodiment of the present invention, the moving picture decoding apparatus is characterized in that the special playback is multiple-fold speed playback or reverse playback, or thumbnail moving picture playback.

In one embodiment of the present invention, the moving picture decoding apparatus is characterized in that the specific data selected and recorded by the first recording section is data including a picture which is to be a reference picture to be referred to for some other picture.

In one embodiment of the present invention, the moving picture decoding apparatus is characterized in that the first type variable length decoding section utilizes time in which sequential decoding is not performed in normal playback to read ahead the input stream data and generate the first stream.

A moving picture encoding apparatus according to the present invention is a moving picture encoding apparatus for encoding a moving picture signal including variable length coded data using arithmetic coding and is characterized by including: a first type variable length coding section for performing first type variable length coding which does not include arithmetic coding to input stream data to generate first type stream data; a second type variable length coding section for performing second type variable length coding including arithmetic coding to the first type stream data generated by the first type variable length coding section to generate second type stream data; a second recording control section for recording the second type stream data generated by the second type variable length coding section in a second recording region; and a third recording control section for selecting only specific data from the first type stream data generated by the first type variable length coding section to record the specific data in a third recording region.

In one embodiment of the present invention, the moving picture encoding apparatus is characterized in that the third recording control section selects data to be used in special playback as the specific data from the first type stream data and records the specific data in the third recording region.

In one embodiment of the present invention, the moving picture encoding apparatus is characterized in that the special playback is multiple-fold speed playback or reverse playback, or thumbnail moving picture playback.

In one embodiment of the present invention, the moving picture encoding apparatus is characterized in that the specific data selected and recorded by the third recording control section is data including a picture which is to be a reference picture to be referred to for some other picture.

In one embodiment of the present invention, the moving picture encoding apparatus is characterized in that the second recording region in which the second type stream data is recorded in a transportable recording media by the second recording control section exists, and the third recording control section does not record the specific data in the third recording region.

In one embodiment of the present invention, the moving picture encoding apparatus is characterized in that the second recording region in which the second type stream data is recorded in a non-transportable recording media by the second recording control section exists, and the second recording control section does not record the specific data which has been recorded as the first type stream data by the third recording control section in the third recording region as the second type stream data in the second recording region.

A moving picture encoding/decoding apparatus according to the present invention is a moving picture encoding/decoding apparatus for decoding a moving picture signal including variable length coded data using arithmetic coding and then encoding the moving picture signal and is characterized in that the apparatus includes: a first type variable length decoding section for performing first type variable length decoding including arithmetic decoding to input stream data to generate first type stream data; a fourth recording control section for selecting only specific data from the first type stream data generated by the first type variable length decoding section to record the specific data in a fourth recording region; and a fifth recording control section for recording the input stream data without data conversion in a fifth recording region, and in copying a data stream of a transportable recording media onto a non-transportable recording media, the data stream of the transportable recording media is copied onto the fourth recording region and the fifth recording region in the non-transportable recording media using the fourth recording control section and the fifth recording control section.

A moving picture encoding/decoding apparatus according to the present invention is a moving picture encoding/decoding apparatus for decoding a moving picture signal including variable length coded data using arithmetic coding and then encoding the moving picture signal and is characterized in that the apparatus includes: a second variable length coding section for performing second type variable length coding including arithmetic coding to specific stream data which has not been arithmetic coded out of input stream data to generate second type stream data; and a sixth recording control section for selecting one of the input stream data and the second type stream data generated by the second variable length coding section and recording the selected one as a single stream data in the sixth recording region, and in copying a data stream from a non-transportable recording media onto a transportable recording media, the specific stream data of the input stream data which has not been arithmetic coded is recorded as the second type stream data in a sixth recording region of the transportable recording media.

A moving picture decoding method according to the present invention is a moving picture decoding method for decoding a moving picture signal including variable length coded data using arithmetic coding and is characterized by including: a first type variable length decoding step of performing first type variable length decoding including arithmetic decoding to input stream data to generate first type stream data; a second type variable length decoding step of performing second type variable length decoding which does not include arithmetic decoding to the first type stream data generated in the first type variable length decoding step to generate output data; and a first recording control step of selecting only specific data from the first type stream data generated in the first type variable length decoding step to record the specific data in the first recording region.

In one embodiment of the present invention, the moving picture decoding method is characterized in that in the second type variable length decoding step, in generating the output data, the specific data of the first type stream data is received from the first recording region, a data stream generated in the first type variable length decoding step is received as the first type stream data other than the specific data and second type variable length decoding which does not include arithmetic decoding is performed.

A moving picture encoding method according to the present invention is a moving picture encoding method for encoding a moving picture signal including variable length coded data using arithmetic coding and is characterized by including: a first type variable length coding step of performing first type variable length coding which does not include arithmetic coding to input stream data to generate first type stream data; a second type variable length coding step of performing second type variable length coding including arithmetic coding to the first type stream data generated in the first type variable length coding step to generate second type stream data; a second recording control step of recording the second type stream data generated in the second type variable length coding step in a second recording region; and a third recording control step of selecting only specific data from the first type stream data generated in the first type variable length coding section to record the specific data in a third recording region.

In one embodiment of the present invention, the moving picture decoding apparatus is characterized in that each of the first type variable length decoding section, the second type variable length decoding section and the first recording control section is provided as an integrated circuit.

In one embodiment of the present invention, the moving picture decoding apparatus is characterized in that each of the first type variable length decoding section, the second type variable length decoding section, the second recording control section and the third recording control section is provided as an integrated circuit.

A moving picture decoding program according to the present invention is a moving picture decoding program for making a computer execute decoding of a moving picture signal including variable length coded data using arithmetic coding and is characterized by including: a first type variable length decoding step of performing first type variable length coding including arithmetic coding to input stream data to generate first type stream data; a second type variable length decoding step of performing second type variable length decoding which does not include arithmetic decoding to the first type stream data generated in the first type variable length decoding step to generate output data; and a first recording control step of selecting only specific data from the first type stream data generated in the first type variable length decoding step to record the specific data in the first recording region.

A moving picture encoding program is a moving picture encoding program for making a computer execute encoding of a moving picture signal including variable length coded data using arithmetic coding and is characterized by including: a first type variable length coding step of performing first type variable length coding which does not include arithmetic coding to input stream data to generate first type stream data; a second type variable length coding step of performing second type variable length coding including arithmetic coding to the first type stream data generated in the first type variable length coding step to generate second type stream data; a second recording control step of recording the second type stream data generated in the second type variable length coding step in a second recording region; and a third recording control step of selecting only specific data from the first type stream data generated in the first type variable length coding section to record the specific data in a third recording region.

As has been described, according to the present invention, of first type stream data to which first type variable length decoding including arithmetic decoding has been performed, special data, for example, key frames necessary for special playback has been already recorded in a recording region. Thus, in performing special playback such as multiple-fold speed playback, reverse playback and the like, sequential processing per several bits which is needed in arithmetic decoding is not necessary for the key frames. Accordingly, even in the case of a moving picture signal including variable length coded data using arithmetic coding, a decoding time is reduced and smooth special playback can be performed in the same manner as in the case of known special playback of a known moving picture signal which does not include variable length coded data using arithmetic coding.

Specifically, according to the present invention, for a key frame (special data) necessary in performing special playback, arithmetic decoding is performed before playback timing at which playback actually has to be performed so that the key frame is prepared as first type stream data. Accordingly, there is an increased possibility that such a key frame exists as the first type stream data in a recording region at all the time. Therefore, smooth special playback can be more reliably performed in the same manner as in the case of known special playback of a moving picture signal which does not include variable length coded data using arithmetic coding.

Moreover, according to the present invention, in other applications than playback by a decoding apparatus or an encoding/decoding apparatus itself, only a stream compliant with coding specifications is generated. Thus, playback with compatibility with different models or competitors' products can be achieved and also in recording and playback by a moving picture decoding apparatus or a moving picture encoding/decoding apparatus itself, smooth special playback can be performed in the same manner as in the case of known special playback of a moving picture signal which does not include variable length coded data using arithmetic coding.

Furthermore, according to the present invention, when a non-transportable recording media such as HDD and the like includes two recording regions and a key frame (special data) necessary in performing special playback has been already recorded as first stream data to which it is not necessary to perform arithmetic decoding in one of the recorded regions, the key frame is not redundantly recorded as second stream data in the other recording region. Accordingly, while the recording regions are efficiently used, smooth special playback can be performed in the same manner as in the case of known special playback of a moving picture signal which does not include variable length coded data using arithmetic coding.

In addition, according to the present invention, when a data stream is copied from a transportable recording media such as DVD and the like to a non-transportable recording media such as HDD and the like, special data such as a key frame and the like which is necessary in performing special playback is recorded in a recording region by the fourth recording control section in a state where the special data has been converted up to first stream data which does not require arithmetic decoding. Accordingly, for example, after a data stream has been copied from DVD to HDD, when a moving picture is played back from the HDD, even in the case of a moving picture signal including variable length coded data using arithmetic coding, a decoding time is reduced and smooth special playback can be performed in the same manner as in the case of known special playback of a moving picture signal which does not include variable length coded data using arithmetic coding.

Furthermore, according to the present invention, when a non-transportable recording media such as HDD and the like in which first type stream data obtained by performing arithmetic decoding to special data such as a key frame and the like which is necessary in performing special playback exists and a data stream is copied from the HDD or the like to a transportable recording media such as DVD and the like, the special data such as a key frame and the like is recorded in a recording region in the transportable recording media such as DVD and the like by the sixth recording control section in a state where the special data has been converted up to second type stream data which does not require arithmetic decoding. Accordingly, a stream out of coding specifications can be copied as a stream compliant with the coding specifications. Therefore, for a transportable recording media after a stream has been copied, playback with compatibility with different models and competitors' products can be ensured and also even in the case of a moving picture signal including variable length coded data using arithmetic coding, in recording and reproducing using HDD built in a moving picture decoding apparatus, a moving picture encoding/decoding apparatus itself or the like, a decoding time is reduced and smooth special playback can be performed in the same manner as in the case of known special playback of a moving picture signal which does not include variable length coded data using arithmetic coding.

### BRIEF DESCRIPTION OF THE DRAWINGS

FIG. 1 is a block diagram of a moving picture decoding apparatus implementing a first embodiment of the present invention.

FIG. 2 is a block diagram illustrating details of a variable length decoding block of the moving picture decoding apparatus.

FIG. 3 is a flow chart showing an intermediate stream storing/selecting flow in the moving picture decoding apparatus in reproducing a picture.

FIG. 4 is a flow chart showing a playback stream selecting flow in the moving picture decoding apparatus.

FIG. 5A is a timing chart schematically showing processing timing in normal playback in the moving picture decoding apparatus; FIG. 5B is a timing chart schematically showing how three-fold speed playback is performed; and FIG. 5C is a timing chart schematically showing how 15-fold speed playback is performed.

FIG. 6A is a timing chart showing timing for first variable length decoding in reverse playback in the moving picture decoding apparatus; and FIG. 6B is a timing chart showing timing for second type variable length decoding in the reverse playback.

FIG. 7 is a block diagram of a moving picture encoding/decoding apparatus implementing a second embodiment of the present invention.

FIG. 8 is a block diagram illustrating details of a variable length coding/decoding block of the moving picture encoding/decoding apparatus.

FIG. 9 is a flow chart showing an intermediate stream storing/selecting flow in the moving picture decoding apparatus in recording a picture.

FIG. 10 is a flow chart showing a modified intermediate stream storing/selecting flow in the moving picture decoding apparatus in recording a picture.

FIG. 11 is a block diagram illustrating a configuration of a transcoder from a DVD format to a HDD format.

FIG. 12 is a block diagram illustrating a configuration of a transcoder from a HDD format to a DVD format.

FIG. 13 is a block diagram of an AV processing section implementing a H.264 recorder.

FIGS. 14A, 14B and 14C are overall schematic views illustrating a case where the present invention is implemented by a computer system.

FIG. 15 is a block diagram illustrating a configuration of a known moving picture encoding apparatus.

FIG. 16 is a block diagram illustrating a configuration of a known moving picture decoding apparatus.

FIG. 17A is a timing chart schematically showing signal processing timing for normal playback in the known moving picture decoding apparatus; FIG. 17B is a timing chart schematically showing decoding timing for three-fold speed playback in the known moving picture decoding apparatus; and FIG. 17C is a timing chart schematically showing decoding timing for 15-fold speed playback in the known moving picture decoding apparatus.

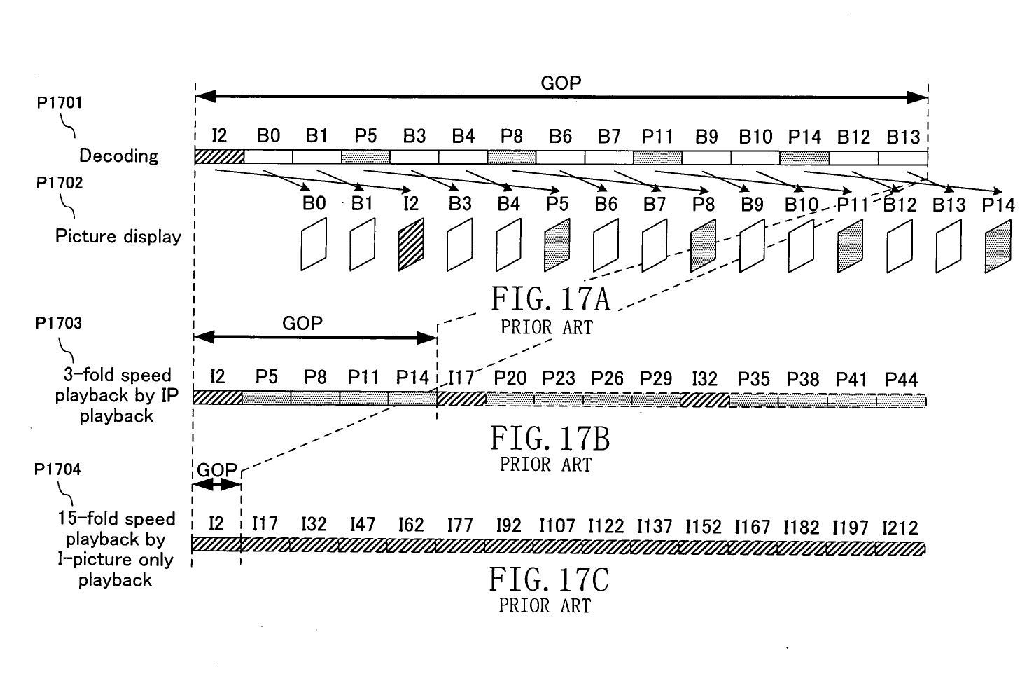

FIG. 18A is a timing chart schematically showing how first decoding in reverse playback of a moving picture signal in the known moving picture decoding apparatus; FIG. 18B is a timing chart schematically showing how subsequent second decoding is performed; FIG. 18C is a timing chart schematically showing how third decoding is performed; FIG. 18D is a timing chart schematically showing how fourth decoding is performed; and FIG. 18E is a timing chart schematically showing how fifth decoding is performed.

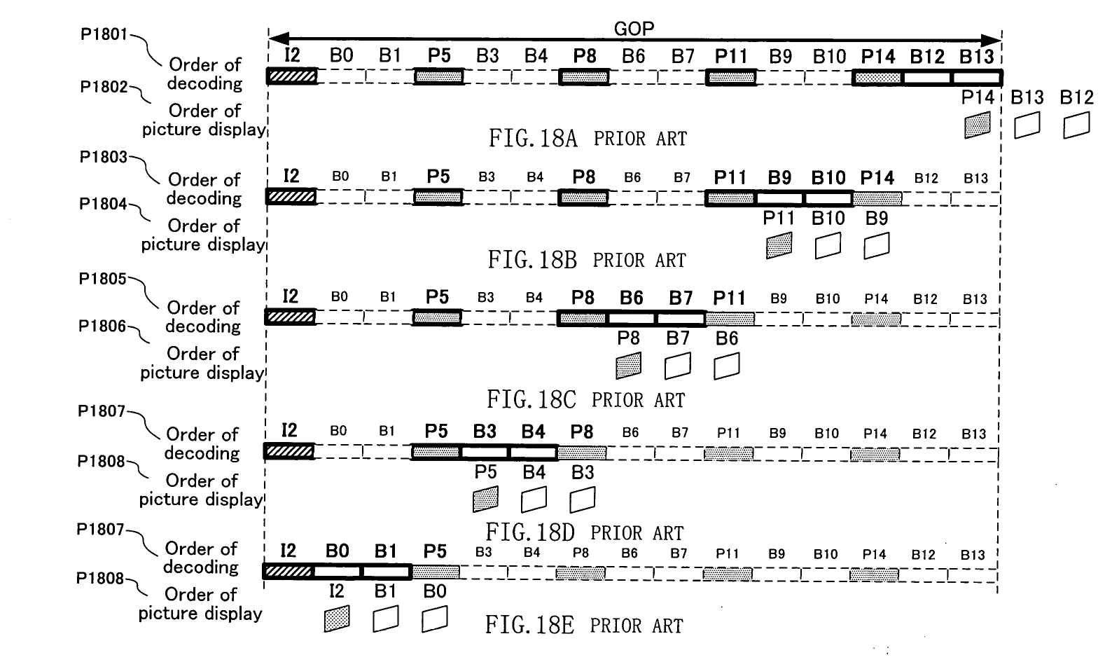

FIG. 19A is a timing chart schematically showing decoding timing in normal playback in the known moving picture decoding apparatus; FIG. 19B is a timing chart schematically showing processing timing to aim three-fold speed processing in the known moving picture decoding apparatus; and FIG. 19C is a timing chart schematically showing processing timing to aim 15-fold speed processing in the known moving picture decoding apparatus.

FIG. 20A is a timing chart schematically showing processing timing in normal playback of a stream including arithmetic coding in the known moving picture decoding apparatus; and FIG. 20B is a timing chart showing first variable length decoding including arithmetic coding.

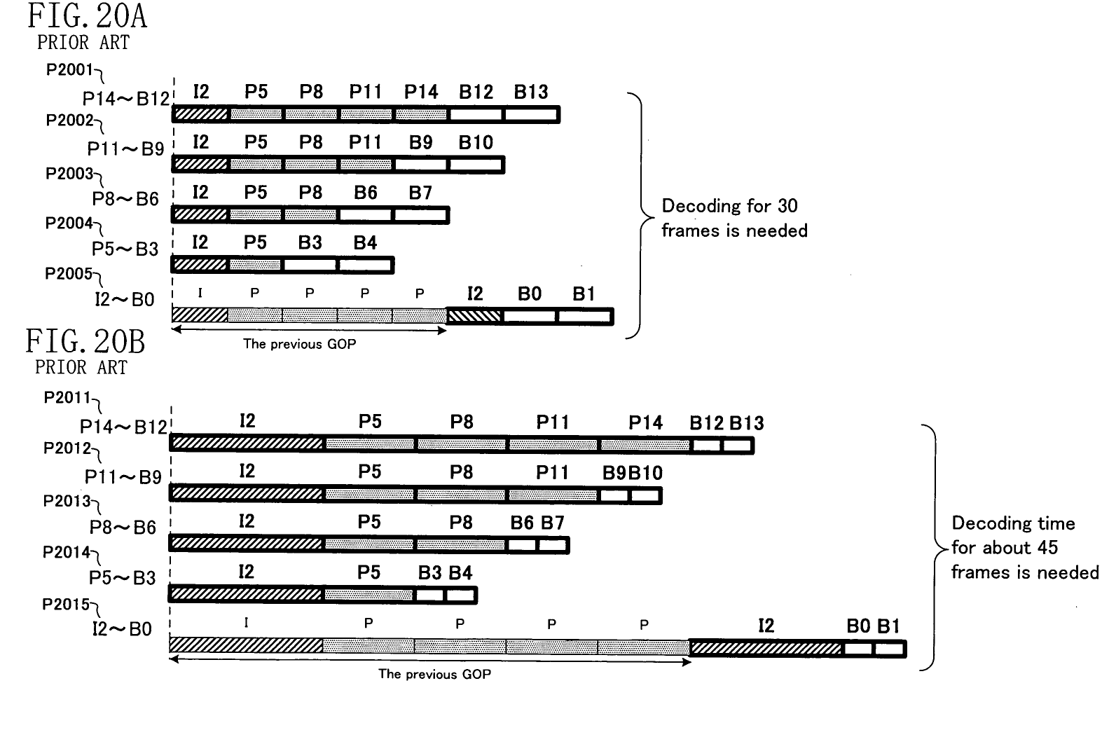

### DESCRIPTION OF THE PREFERRED EMBODIMENTS

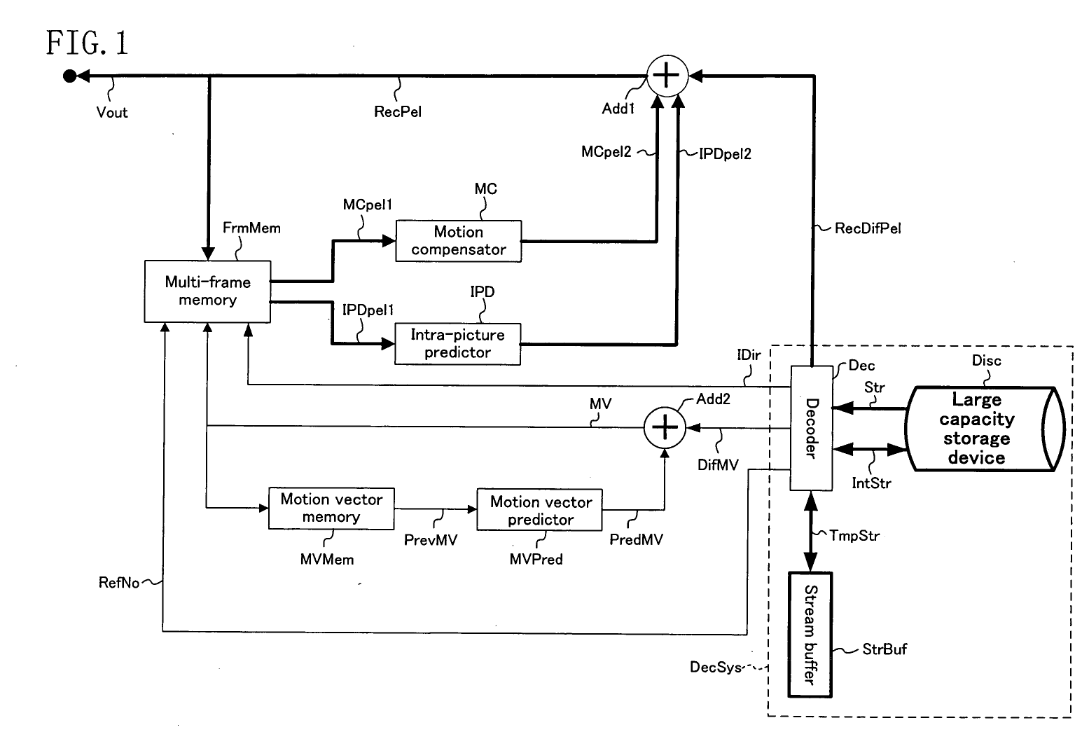

Hereafter, preferred embodiments of the present invention will be described with reference to FIGS. 1 though 14.

### First Embodiment

A first embodiment of the present invention will be described hereafter with reference to FIGS. 1 thorough 6.

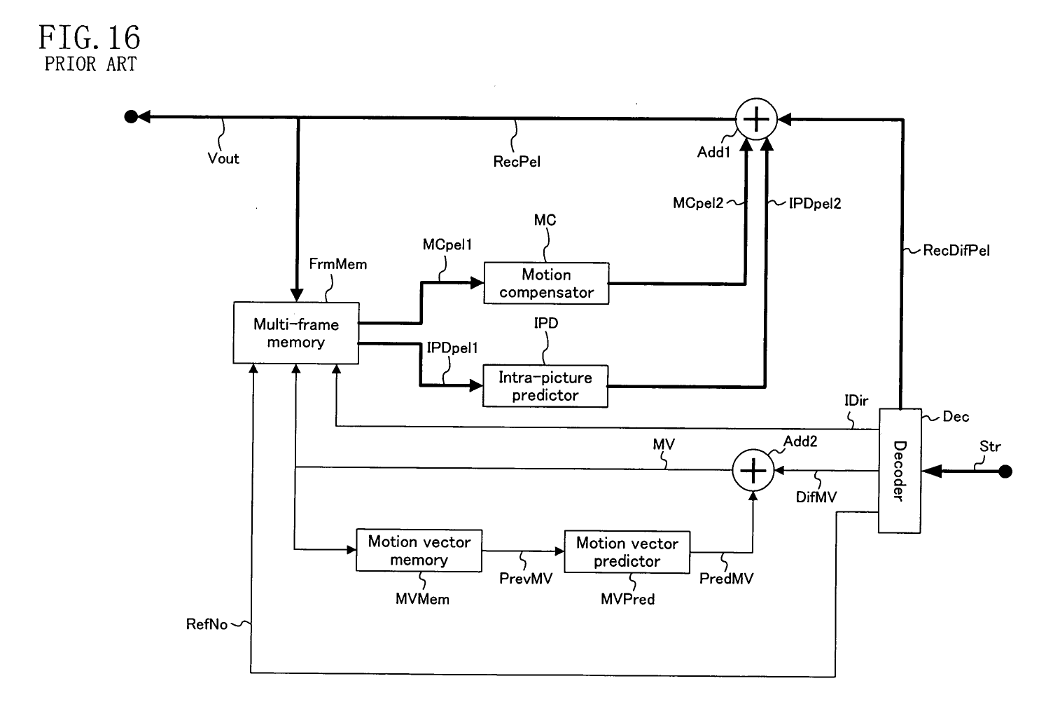

FIG. 1 is a block diagram of a moving picture decoding apparatus 1 implementing this embodiment. In FIG. 1, each member also shown in FIG. 16 is identified by the same reference numeral and therefore the description thereof will be omitted. A configuration of FIG. 1 is different from the configuration of FIG. 16 in that a large capacity storage device Disc and a stream buffer StrBuf are added to the configuration of FIG. 16. The moving picture decoding apparatus 1 of FIG. 1 is provided on a semiconductor chip as an integrated circuit.

A decoder Dec of this embodiment not only receives a known coding signal Str but also receives/outputs an intermediate stream IntStr which is generated by the decoder Dec when decoding is performed and is connected to the large capacity storage device Disc. A stream buffer StrBuf for temporarily storing the coded signal Str and the intermediate stream IntStr is connected to the decoder Dec via an intermediate stream TmpStr.

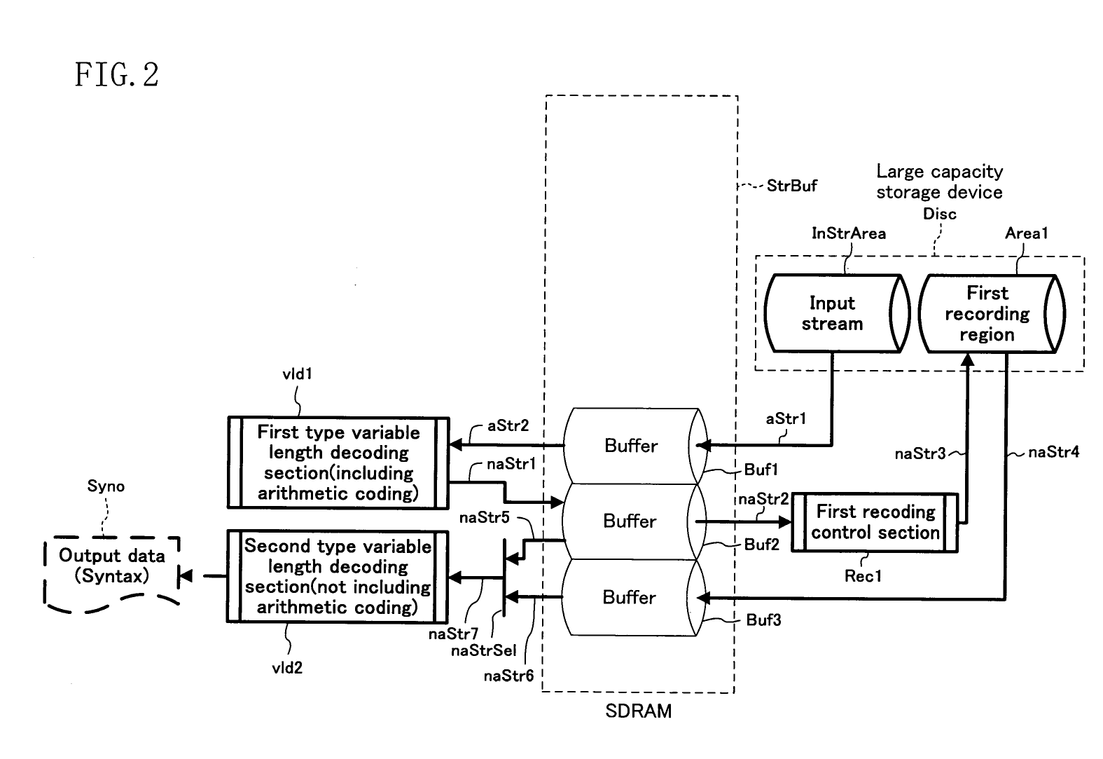

Now, to explain a flow of decoding of the coded signal Str including arithmetic coded data according to this embodiment in detail, a variable length coding/decoding block DecSys including the decoder Dec, the large capacity storage device Disc and the stream buffer StrBuf will be described with reference to FIG. 2.

FIG. 2 is a detailed block diagram of a variable length coding/decoding block DecSys. In FIG. 2, each member also shown in FIG. 1 is identified by the same reference numeral and the description thereof will be omitted.

The decoder Dec includes a first type variable length decoding section vld1 for performing variable length decoding including arithmetic decoding (which will be hereafter referred to as “first type variable length decoding”), a second type variable length decoding section vld2 for performing other variable length decoding which does not include arithmetic coding (which will be hereafter referred to as “second type variable length decoding”), and a first recoding control section Rec1 for selectively storing an intermediate stream generated in the first type variable length decoding section vld1. Moreover, the large capacity storage device Disc connected to the decoder Dec includes an input stream region InStrArea and a first recording region Area1. The stream buffer StrBuf includes a buffer 1Buf1, a buffer 2Buf2 and a buffer 3Buf3 as temporary buffers. Hereafter, a detailed flow of a signal will be described with reference to FIG. 2. The following processing may be implemented as a moving picture decoding program executed by a computer.

First, an arithmetic coded signal 1aStr1 is read from the input stream region InStrArea of the large capacity storage device Disc such as DVD, HDD and the like and stored in the buffer 1Buf1. The coded signal stored in the buffer 1Buf1 is received as an arithmetic coded signal 2aStr2 by the first type variable length decoding section vld1 and is converted to a stream (which will be hereafter referred to as “first type stream data”) which does not include arithmetic coded data in the first type variable length decoding section vld1. Then, a non-arithmetic coded signal 1naStr1 which does not include arithmetic coded data is stored in the buffer 2Buf2.

Next, in the first recoding control section Rec1, a key frame such as an I-picture and a P-picture which is necessary for special playback is selected, a non-arithmetic signal 2naStr2 which does not includes arithmetic coded data is read from the buffer 2Buf2 and the read non-arithmetic signal is stored as a non-arithmetic coded signal 3naStr3 in the first recording region Area1. Furthermore, after the storing the non-arithmetic coded signal 3naStr3, a non-arithmetic coded signal 4naStr4 is read from the first recording region Area1 and is stored in the buffer 3Buf3.

Finally, a non-arithmetic coded signal 5naStr5 from the buffer 2Buf2and a non-arithmetic coded signal 6naStr6 from the buffer 3Buf3 are received by the decoded stream selector (selecting section) naStrSel. Then, one the coded signals from the buffer 2Buf2 and the buffer 3Buf3 is selected according to conditions and a selected coded signal is received as a non-arithmetic coded signal 7naStr7 by the second type variable length decoding section vld2. Furthermore, in the second type variable length decoding section vld2, final output data Syno such as an intra-picture prediction direction IDir, a picture prediction error DifPel, a motion vector prediction difference DifMV, a reference frame number RefNo and the like is output.

<Flow of Storing Intermediate Stream>

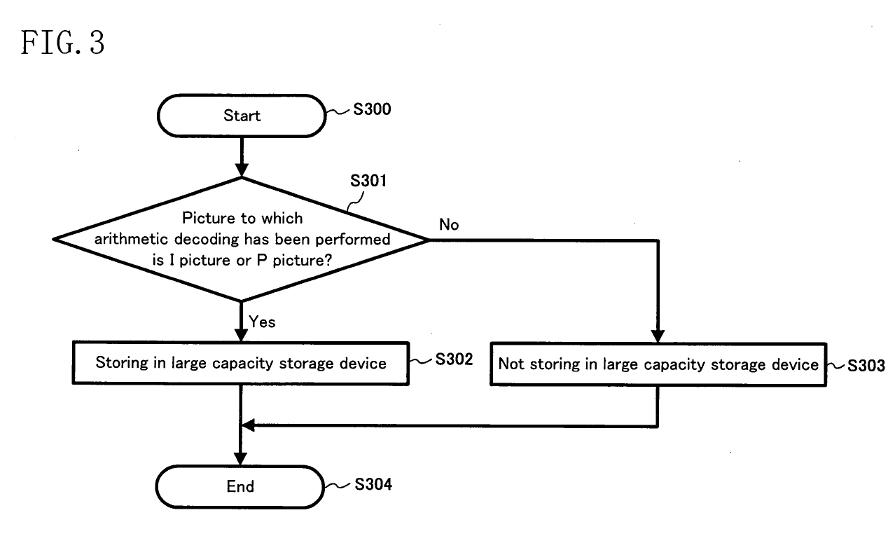

Next, process steps for selecting the non-arithmetic coded signal 3naStr3 to be recorded in the first recording region Area1 in the first recoding control section Rec1 will be described with reference to FIG. 3. FIG. 3 shows a flow of storing intermediate stream when playback for realizing this embodiment is performed.

First, it is judged whether or not a non-arithmetic coded signal naStr2 which is one of coded signals stored in the buffer 2Buf2 and is to be stored is a key frame such as an I-picture and a P-picture (Step S301). If the non-arithmetic coded signal naStr2 is a key frame which can be effectively utilized in special playback, a non-arithmetic coded signal naStr3 is output and stored in the first recording region Area1 of the large capacity storage device Disc (Step S302). On the other hand, if the non-arithmetic coded signal naStr2 is not a key frame, the non-arithmetic coded signal naStr2 is not stored in the first recording region Area1 (Step S303). After the above-described steps have been performed, the same process steps are repeatedly performed to a subsequent non-arithmetic coded signal naStr2 in the same order.

The above-described flow of storing is performed, for example, using an encoding/decoding apparatus during a time when a user selects a stream (program) before performing main playback, a time when thumbnail images are generated for the selection, an non-operation time when a user does not use the encoding/decoding apparatus, or a time when the encoding/decoding apparatus is not in an operation state while main playback is performed, so that an intermediate stream is generated.

<Flow of Selecting Intermediate Stream>

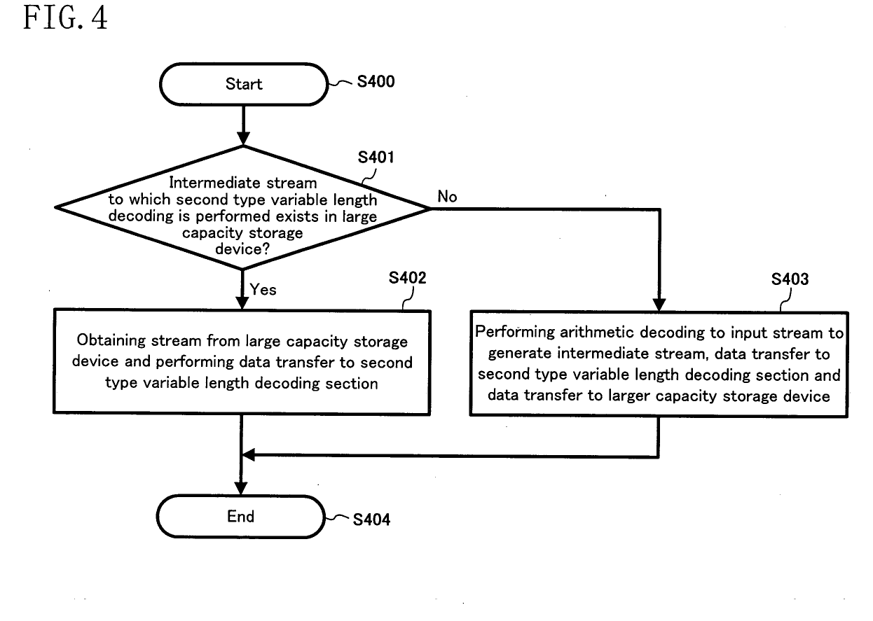

Subsequently, a flow of selecting a data stream in a decoded stream selector naStrSel will be described with reference to FIG. 4. FIG. 4 shows a flow of selecting a stream to be played back, which implements this embodiment.

First, it is judged whether or not an intermediate stream to which a variable length decoding exists in the large capacity storage device Disc or the buffer 3Buf3 (Step S401). If the intermediate stream exists, a non-arithmetic coded signal 6naStr6 is read from the buffer 3Buf3 and is output as a non-arithmetic coded signal 7naStr7, and subsequent decoding is performed in a second type variable length decoding section vld2 (Step S402). If the intermediate stream does not exist, a non-arithmetic coded signal 5naStr5 is read from the buffer 2Buf2 and is output as a non-arithmetic coded signal 7naStr7, and subsequent decoding is performed in the second type variable length decoding section vld2 (Step S403). At this time, in the case of reproducing a key frame, in addition to the above-described process steps, storing data into the large capacity storage device Disc using the first recoding control section Rec1 is performed, so that the first type variable length decoding when the same key frame is needed in a subsequent process step becomes unnecessary.

<Improvement of Multiple-Fold Speed Playback Performance>

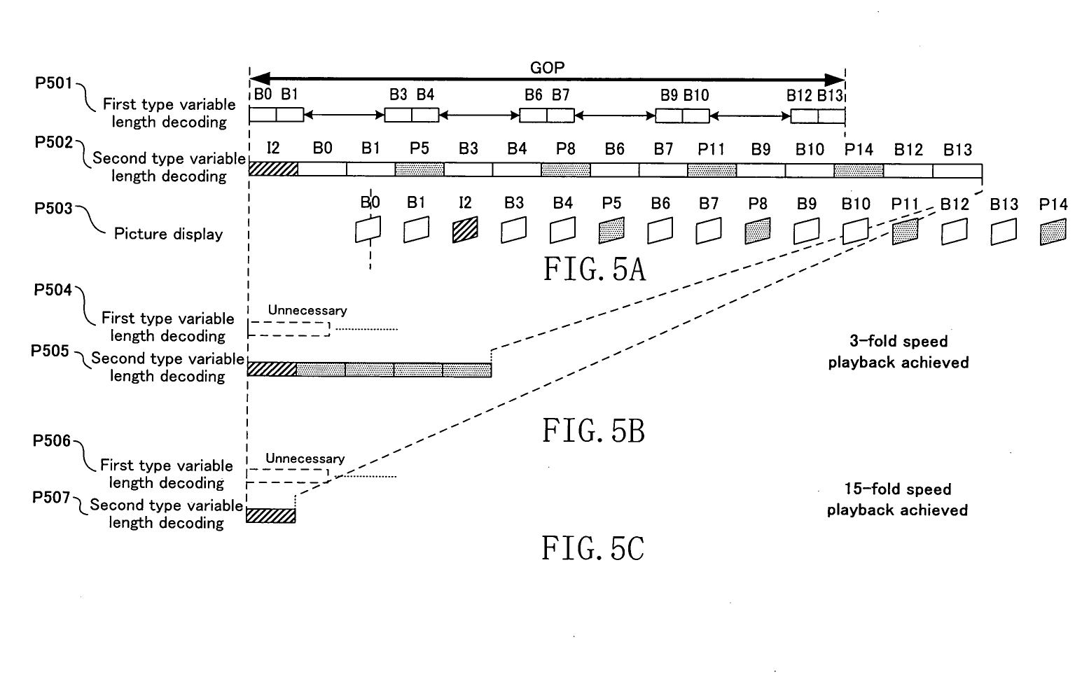

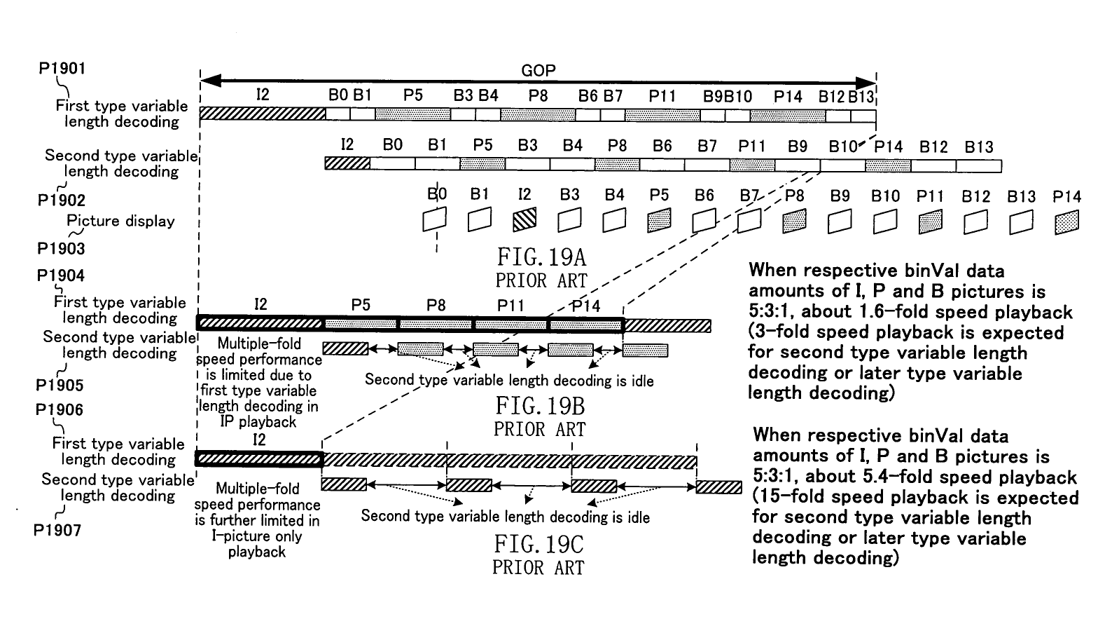

By the above-described signal flow and control, multiple-fold speed playback performance when a stream including arithmetic coded data is played back can be improved. This will be described with reference to FIGS. 5A through 5C. FIGS. 5A through 5C are schematic views showing how multiple-fold speed playback implemented by this embodiment is performed. FIG. 5A shows timing of normal playback when a function structure described in this embodiment is used. In this case, as in the description of the FIG. 19, processing timing within 1 GOP is shown.

A timing chart P501 shows timing of the first type variable length decoding in this embodiment. Since key frames such as I-pictures and P-pictures exist as intermediate streams in the first recording region Area1, the first type variable length decoding is not necessary for the key frames. Accordingly, timing of decoding only B-pictures is shown. In this case, an interval between pictures B1 and B3, an interval between pictures B4 and B5 or the like, is an interval in which the first type variable length decoding is not performed. Thus, utilizing the intervals, the first type variable length decoding in some other time position or of a key frame stream may be performed. As a matter of course, if an intermediate stream does not exist in the first recording region Area1, the first type variable length decoding is performed with the same timing as in the known decoding technique.

A timing chart P502 shows timing of the second type variable length decoding in this embodiment. Although an intermediate stream might be output from a different source, the second type variable length decoding is performed with the same timing as in the timing chart 1902 of FIG. 19B. Moreover, a timing chart P503 shows timing of picture display. Also, the picture display of the timing chart P503 is performed with the same timing as in the timing chart P1903 of FIG. 19C.

Next, multiple-fold speed playback will be described. FIG. 5B shows timing in multiple-fold speed playback employing IP playback. In this case, when IP playback is performed, the first type variable length decoding for I-pictures and P-pictures is not needed, and thus, as shown in a timing chart P504, the first type variable length decoding does not have to be performed. Accordingly, as shown in a timing chart P505, the second type variable length decoding can be performed to I-pictures and P-pictures without being restricted by timing of the first type variable length decoding, so that desired three-fold speed playback can be achieved.

FIG. 5C shows timing of high speed multiple-fold speed playback employing playback of only I-pictures. In this case, when only I-pictures are played back, the first type variable length decoding for the I-pictures is not needed, and thus, as shown in a timing chart P506, the first type variable length decoding does not have to be performed. Accordingly, as shown in a timing chart P507, the second type variable length decoding can be performed to the I-pictures without being restricted by timing of the first type variable length coding, so that desired 15-fold speed playback can be achieved.

<Improvement of Reverse Playback Performance>

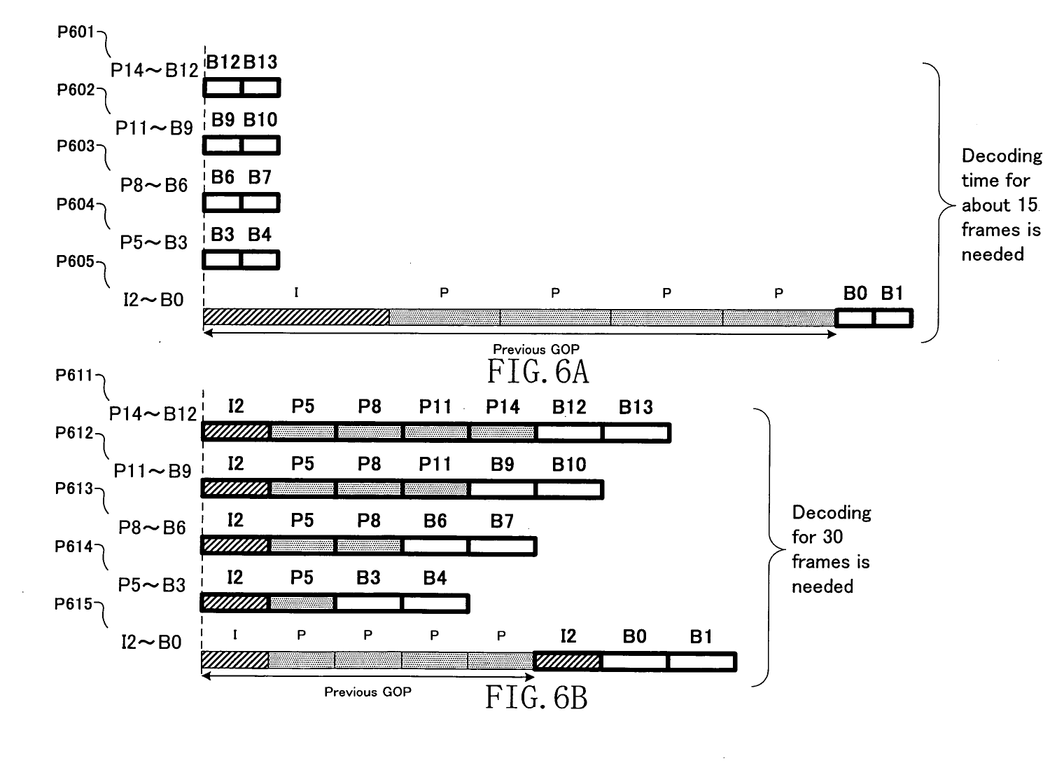

By the above-described signal flow and control, reverse playback performance when a stream including arithmetic coded data is played back can be improved. This will be described with reference to FIGS. 6A and 6B. FIGS. 6A and 6B are schematic views showing how reverse playback implemented by this embodiment is performed. FIGS. 6A and 6B show timing of the first type variable length decoding and timing of the second type variable length decoding in reverse playback, respectively, in the case where this embodiment is used.

P601, P602, P603, P604 and P605 are timing charts showing timing for the first type variable length decoding. The timing charts P601, P602, P603, P604 and P605 show decoding of B13 and B12, decoding of B10 and B9, decoding B7 and B6, decoding of B4 and B3B and decoding of B1 and B0, respectively, and are connected in the ascending order from P601 to P605 in terms of time. As shown in the timing charts P601 through P604 of FIG. 6A, the first variable length decoding of key frames such as I-pictures and P-pictures is not needed, and thus only decoding of B-pictures is performed. The timing chart P605 shows that key frame playback of a previous GOP is needed but, even in this portion, when an intermediate stream exists in the first recording region Area1, key frame playback of a previous GOP is not needed.

P611, P612, P613, P614 and P615 are timing charts showing timing for the second type variable length decoding and are connected in the ascending order from P611 to P615 in terms of time. The timing charts P611, P612, P613, P614 and P615 show decoding of P14, B13 and B12, decoding of P11, B10 and B9, decoding P8, B7 and B6, decoding of P5, B3 and B4 and decoding of 13, B1 and B0, respectively. As a result of the decoding shown in the timing charts, reverse playback is performed. In this case, in each decoding of the timing charts P611, P612, P613, P614 and P615, playback can not be performed without another key frame. Therefore, for example, in the timing chart P611, even if only P14, B13 and B12 are desired to be decoded, decoding of 12, P5, P8 and P11 are performed, in addition to decoding P14, B13 and B12. Decoding in P611, P612, P613 and P614 is performed all in the same manner and the timing chart P611 shows that decoding of a key frame existing in a GOP immediately before a playback target is needed.

As has been described, when reverse playback is performed, playback can be performed such that timing of the second type variable length decoding is not restricted by the first type variable length decoding including arithmetic coding. Accordingly, for the first type variable length decoding, reverse playback can be performed without requiring any improvement of processing power, and even for the second type variable length decoding, smooth reverse playback can be performed by processing power required in the known technique (i.e., processing power allowing about double speed operation).

All of I-pictures and P-pictures do not have to be key frames to be stored and held as the first type stream data. Only I-pictures or part of I-pictures may be handled as the key frames. Alternatively, B-pictures may be some of the key frames. Moreover, part of coding blocks constituting a picture may be the key frames.

In this embodiment, as the stream buffer StrBuf, the buffer 1Buf1, the buffer 2Buf2 and the buffer 3Buf3 have been described. However, the apparatus may have a configuration in which part of the stream buffer StrBuf does not exist or a configuration in which the stream buffer StrBuf is divided into parts so that a part thereof exists in a SDRAM externally connected to the apparatus and the rest part thereof serves as a memory in the decoder Dec.

Playback for thumbnail moving pictures is used to reduce the size of recorded pictures and display a list of the pictures. However, when a stream as a moving picture of which the size has been reduced beforehand does not exist, display is performed while reduction in size for a plurality of moving pictures is performed and thus playback has to be performed at higher speed than the speed of normal playback. In this manner, even in the case where a plurality of streams such as thumbnail moving pictures are played back at one time, if an intermediate stream included in the first recording region Area1, the first type variable length decoding is not needed and thus simultaneous playback can be realized in a relatively simple manner.

The large capacity storage device Disc does not have to be formed as a single device or media. For example, the large capacity storage device Disc may be formed so that the input stream region InStrArea is formed in DVD and the first recording region Area1 is formed in HDD.

### Second Embodiment

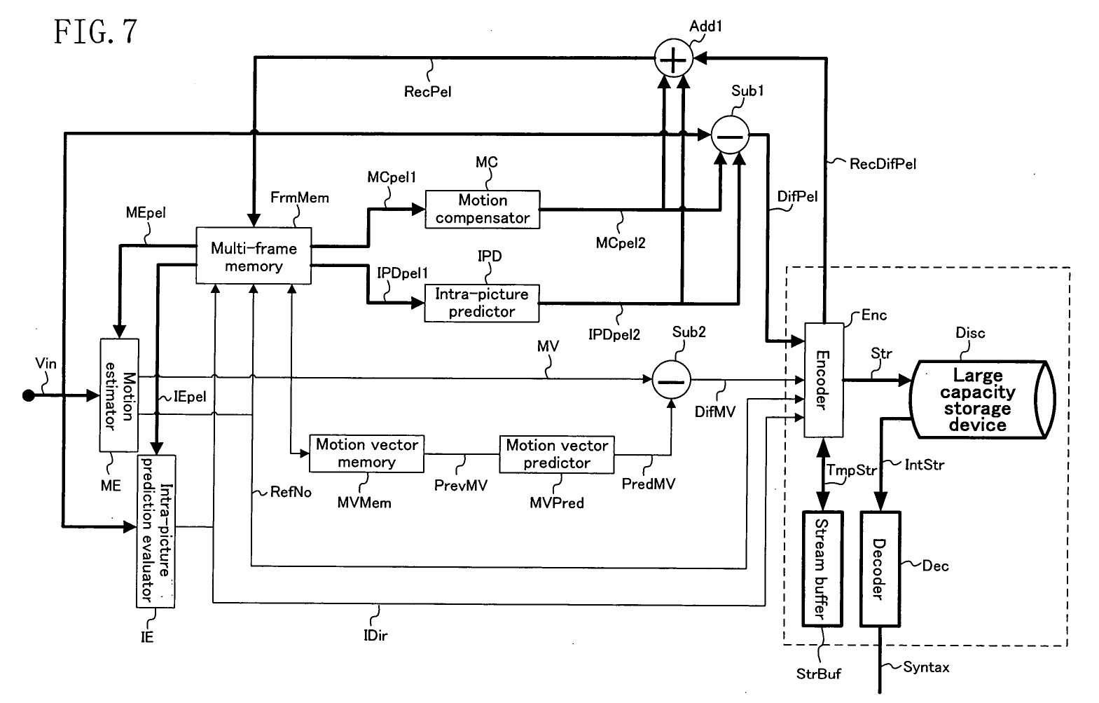

Hereafter, a second embodiment of the present invention will be described with reference to FIGS. 7 through 10.

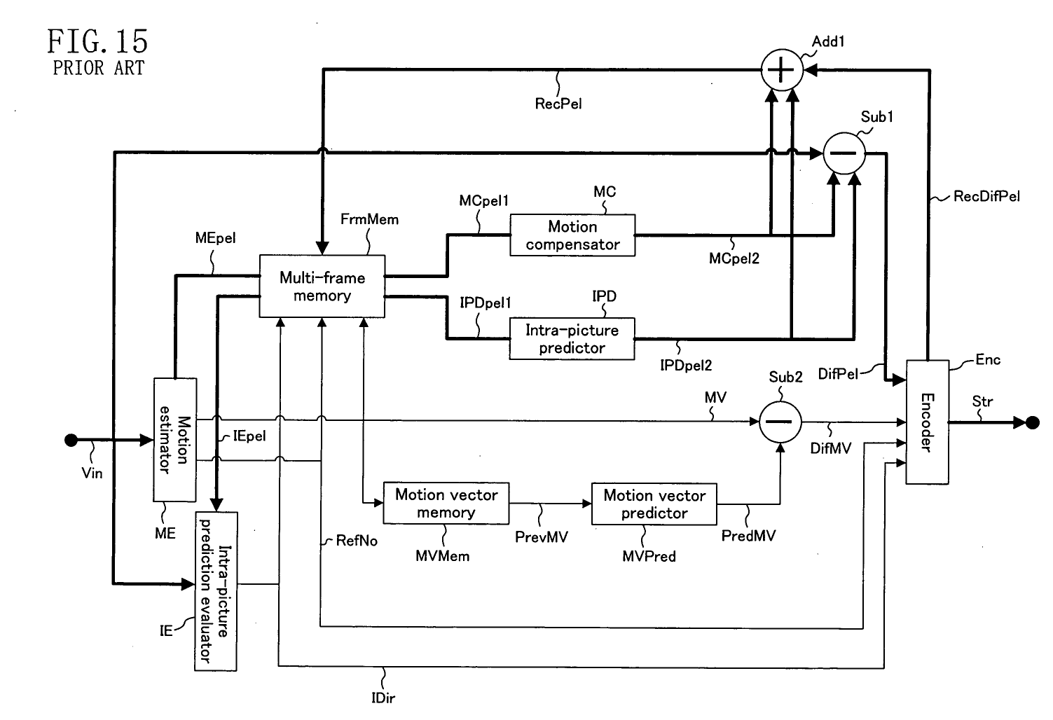

FIG. 7 is a block diagram of a moving picture encoding apparatus 2 implementing this embodiment. In FIG. 7, each member also shown in FIG. 15 is identified by the same reference numeral and therefore the description thereof will be omitted. The configuration of FIG. 7 is different from the configuration of FIG. 15 in that a large capacity storage device Disc and a stream buffer StrBuf are added to the configuration of FIG. 15 and furthermore a decoder Dec as a path for decoding is added thereto. The moving picture encoding apparatus 2 of FIG. 7 is provided on a semiconductor chip to form an integrated circuit.

In this embodiment, a decoder Dec outputs not only a known coding signal Str but also an intermediate stream IntStr which is generated by the decoder Dec when decoding is performed and is connected to the large capacity storage device Disc. A stream buffer StrBuf for temporarily storing the coded signal Str and an intermediate stream TmpStr is connected to the encoder Enc via the an intermediate stream TmpStr.

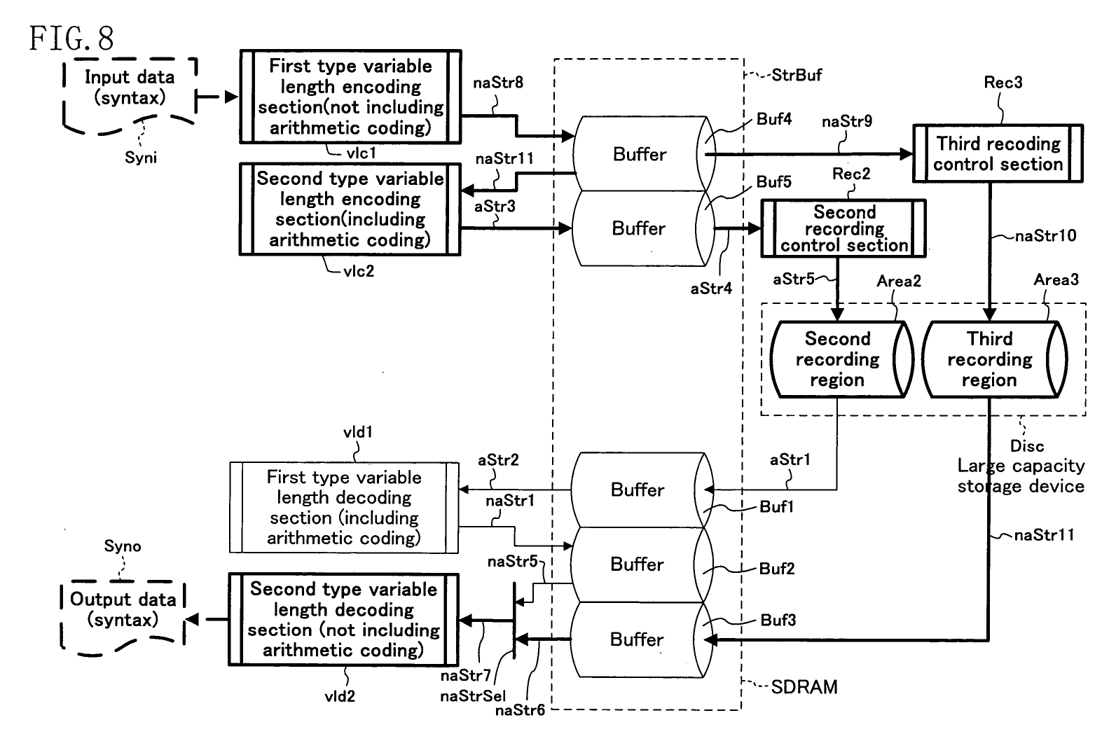

Now, to explain a flow of decoding the coded signal Str including arithmetic coded data of this embodiment in detail, a variable length coding/decoding block EncSys including the decoder Dec, the large capacity storage device Disc and the stream buffer StrBuf will be described with reference to FIG. 8.

FIG. 8 is a detailed block diagram of a variable length coding/decoding block EncSys. In FIG. 8, each member also shown in FIG. 7 or FIG. 2 is identified by the same reference numeral and the description thereof will be omitted.

The encoder Enc includes a first type variable length coding section vlc1 for performing variable length coding which does not include arithmetic coding (which will be hereafter referred to as “first type variable length coding”), a second type variable length coding section vlc2 for performing the rest of variable length coding including arithmetic coding (which will be hereafter referred to as “second type variable length coding”), and a second recoding control section Rec2 for storing a coded signal generated in the second type variable length coding section vlc2 and a third recoding control section Rec3 for storing an intermediate stream (first type stream data) generated in the first type variable length coding section vlc1. Moreover, the large capacity storage device Disc connected to the encoder Enc includes a second recording region Area2 and a third recording region Area3. The stream buffer StrBuf includes as temporary buffers a buffer 4Buf4 and a buffer 5Buf5, as well as a buffer 1Buf1, a buffer 2Buf2 and a buffer 3Buf3. A first type variable length decoding section vld1 and a second type variable length decoding section vld2 are the same components as those indicated by the same reference numerals in FIG. 2.

Hereafter, a detailed flow of a signal will be described with reference to FIG. 2. The following processing may be a moving picture decoding program implemented by computer.

First, input data Syni, which is a syntax such as an intra-picture prediction direction IDir, a picture prediction error DifPel, a motion vector prediction difference DifMV, a reference frame number RefNo and the like is coded in the first type variable length coding section which does not use arithmetic coding to generate a non-arithmetic coded signal 8naStr8 and the non-arithmetic coded signal 8naStr8 is stored in a buffer 4Buf4.

Next, an intermediate stream including a key frame such as an I-picture or a P-picture is read as a non-arithmetic coded signal 9naStr9 from intermediate streams stored in the buffer 4Buf4. Then, the non-arithmetic coded signal 9naStr9 is received by the third recoding control section Rec3, furthermore, a non-arithmetic coded signal 10naStr10 is output from the third recoding control section Rec3 and then the non-arithmetic coded signal 10naStr10 is stored in a third recording region Area3.

Other then the intermediate stream including the key frame stored in the third recording region Area3, each of intermediate streams stored in the buffer 4Buf4 is read as a non-arithmetic coded signal 11naStr11 and is received by the second type variable length coding section vlc2. Furthermore, as a result of arithmetic coding performed to the non-arithmetic coded signal 11naStr11, an arithmetic coded signal (second type stream data) aStr3 is output and stored in a buffer 5Buf5.

Finally, using the second recording control section Rec2, an arithmetic coded signal 4aStr4 is read from the buffer 5Buf5 and is stored as an arithmetic coded signal 5aStr5 in the second recording region Area2.

Next, signal flow in decoding of this embodiment will be described.

First, a stream which has been coded to include arithmetic coded data is read as an arithmetic coded signal 1aStr1 from the second recording region Area2 and is stored in the buffer 1Buf1. Furthermore, in the first type variable length decoding section vld1, an arithmetic coded signal 2aStr2 is read from the buffer 1Buf1. The arithmetic coded signal 2aStr2 is converted to be a coded signal which does not include arithmetic coded data and then data output as the non-arithmetic coded signal 1naStr1 is stored in the buffer 2Buf2.

On the other hand, a coded stream which does not include arithmetic coded data is read as a non-arithmetic coded signal naStr11 from the third recording region Area3 and is stored in the buffer 3Buf3.

Next, a non-arithmetic coded signal 5naStr5 from the buffer 2Buf2 and a non-arithmetic coded signal 6naStr6 from the buffer 3Buf3 are received by the decoded stream selector naStrSel. The decoded stream selector naStrSel selects one of the non-arithmetic coded signal 5naStr5 and the non-arithmetic coded signal 6naStr6 according to conditions and the selected non-arithmetic coded signal is received as a non-arithmetic coded signal 7naStr7 by the second type variable length decoding section vld2. Furthermore, in the second type variable length decoding section vld2, final output data Syno such as the intra-picture prediction direction IDir, the picture prediction error DifPel, the motion vector prediction difference DifMV, the reference frame number RefNo and the like is output.

All of I-pictures and P-pictures do not have to be key frames to be stored and held as the first type stream data. Only I-pictures or part of I-pictures may be handled as the key frames. Alternatively, B-pictures may be some of the key frames. Moreover, part of a coding block constituting a picture may be the key frames.

In this embodiment, as the stream buffer StrBuf, the buffer 1Bufn, the buffer 2Buf2, the buffer 3Buf3, the buffer 4Buf4 and the buffer 5Buf5 have been described. However, the apparatus may have a configuration in which part of the stream buffer StrBuf does not exist or a configuration in which the stream buffer StrBuf is divided into parts so that a part thereof exists in a SDRAM externally connected to the apparatus and the rest part thereof serves as a memory in the decoder Dec.

Moreover, in the case where a plurality of streams such as thumbnail moving pictures are played back at one time, if an intermediate stream included in the second recording region Area2, the first type variable length decoding is not needed and thus simultaneous playback can be realized in a relatively simple manner.

In addition, the large capacity storage device Disc does not have to be formed as a single device or media. For example, the large capacity storage device Disc may be formed so that the second recording region Area2 is formed in DVD and the third recording region Area3 is formed in HDD.

<Flow of Storing Intermediate Stream>

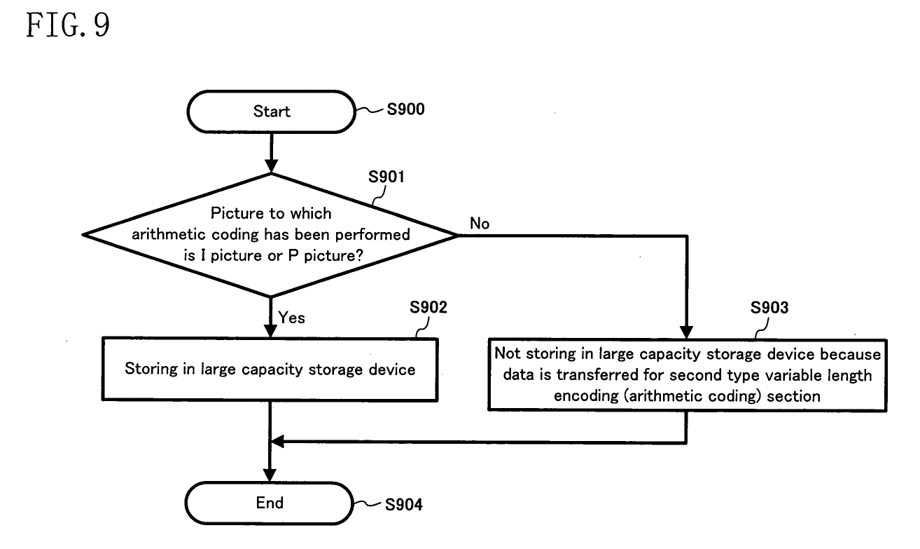

Next, a control method used for selecting the non-arithmetic coded signal 3naStr3 to be recorded in the third recording region Area3 in the third recoding control section Rec3 will be described with reference to FIG. 9. FIG. 9 shows intermediate stream storing/selecting flow 1 when recording is performed according to this embodiment.

First, it is judged whether or not the non-arithmetic coded signal naStr9 which is one of coded signals stored in the buffer 4Buf4 and is to be stored is a key frame such as an I-picture and a P-picture (Step S901). If the non-arithmetic coded signal naStr9 is a key frame which can be effectively utilized in special playback or the like, the non-arithmetic coded signal naStr10 is output from the third recoding control section Rec3 and stored in the third recording region Area3 of the large capacity storage device Disc (Step S902). On the other hand, if it is judged that the non-arithmetic coded signal naStr9 does not include a key frame in Step S902, the second type variable length decoding is performed to the non-arithmetic coded signal naStr9 and then the non-arithmetic coded signal naStr9 is stored in the second recording region Area2 (Step S903). Accordingly, the key frame is stored as the non-arithmetic coded signal naStr10 in the third recording region Area3 but is not stored as the arithmetic coded signal aStr5 in the second recording region Area2. Therefore, for example, when the second recording region Area2 and the third recording region Area3 are located in a non-transportable large capacity storage device Disc such as HDD or the like, a recording region of the HDD can be efficiently utilized.

After the above-described processing has been performed, the same processing is repeatedly performed to a subsequent non-arithmetic coded signal naStr9.

By performing processing according to the above-described storing/selectin flow, a coded signal of a key frame for facilitating special playback is stored as a non-arithmetic coded signal at a time of coding.

As has been described, by mixing a coded stream of a non-arithmetic coded signal and a coded stream of an arithmetic coded signal, smooth special playback can be realized.

As described in this embodiment, however, when a method for storing an arithmetic coded signal as a non-arithmetic coded signal is used, a stream which is out of the original specifications of H.264 is generated. Thus, when a transportable media is used as the large capacity storage device Disc, for example, compatibility is needed for playback using competitors' products and thus a stream within the range of the specification has to be generated.

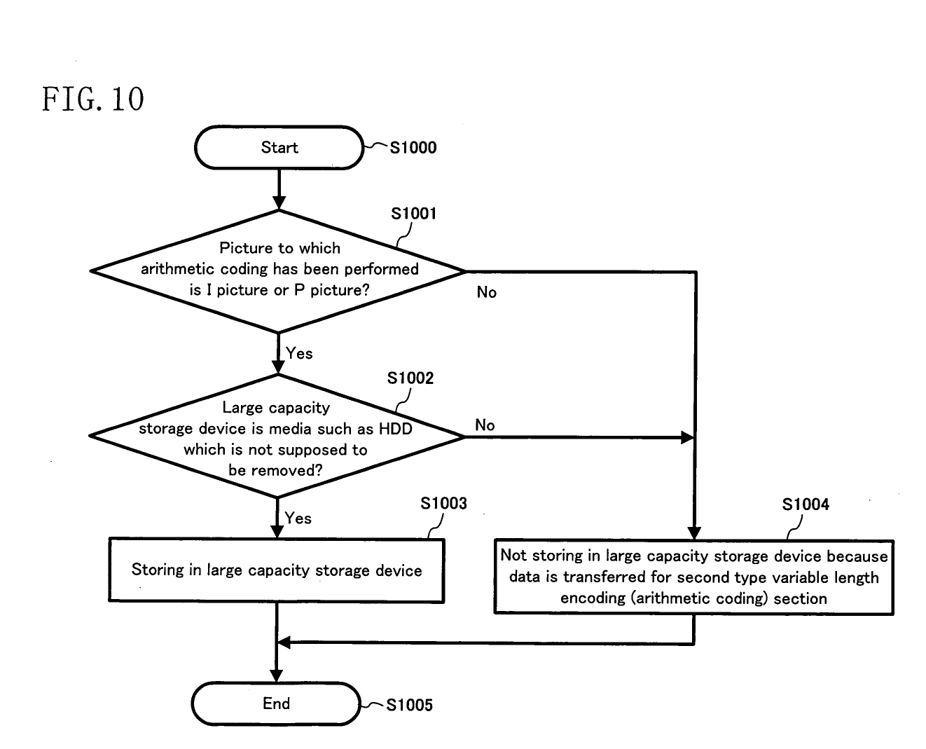

In view of the above-described points, by adding judgment processing to the flow of FIG. 9, a modified example of the intermediate stream storing/selecting flow performed in recording, which implements this embodiment will be shown in FIG. 10.

First, it is judged whether or not a non-arithmetic coded signal NaStr9 which is one of coded signals stored in the buffer 4Buf4 and is to be stored is a key frame such as an I-picture or a P-picture (Step S1001). Furthermore, if the non-arithmetic coded signal naStr9 is a key frame which can be effectively utilized in special playback or the like, whether or not the large capacity storage device Disc is a non-transportable media such as HDD and the like is judged (Step S1002). If it is judged in Step S1002 that the large capacity storage device Disc is a non-transportable media, a non-arithmetic coded signal naStr10 is output by the third recoding control section Rec3 and is stored in the third recording region Area3 of the large capacity storage device Disc (Step S1003). On the other hand, if it is not judged as a result of the judgment of Step S1001 that the non-arithmetic coded signal naStr9 is a key frame, the second type variable length decoding is performed and the non-arithmetic coded signal naStr9 is recorded in the second recording region Area2 (Step S1004). Moreover, if it is judged as a result of the judgment of Step S1002 that the large capacity storage device Disc is a transportable media, Step S1003 of storing a key frame in a transportable media is not performed and the process proceeds to Step S1004.

### Third Embodiment

In this embodiment, copying (duplicating) or moving (transferring) from a transportable medium such as DVD to a non-transportable media such as HDD and copying and moving from a non-transportable media such as HDD to a transportable medium such as DVD will be described.

<Transportable Media to Non-Transportable Media>

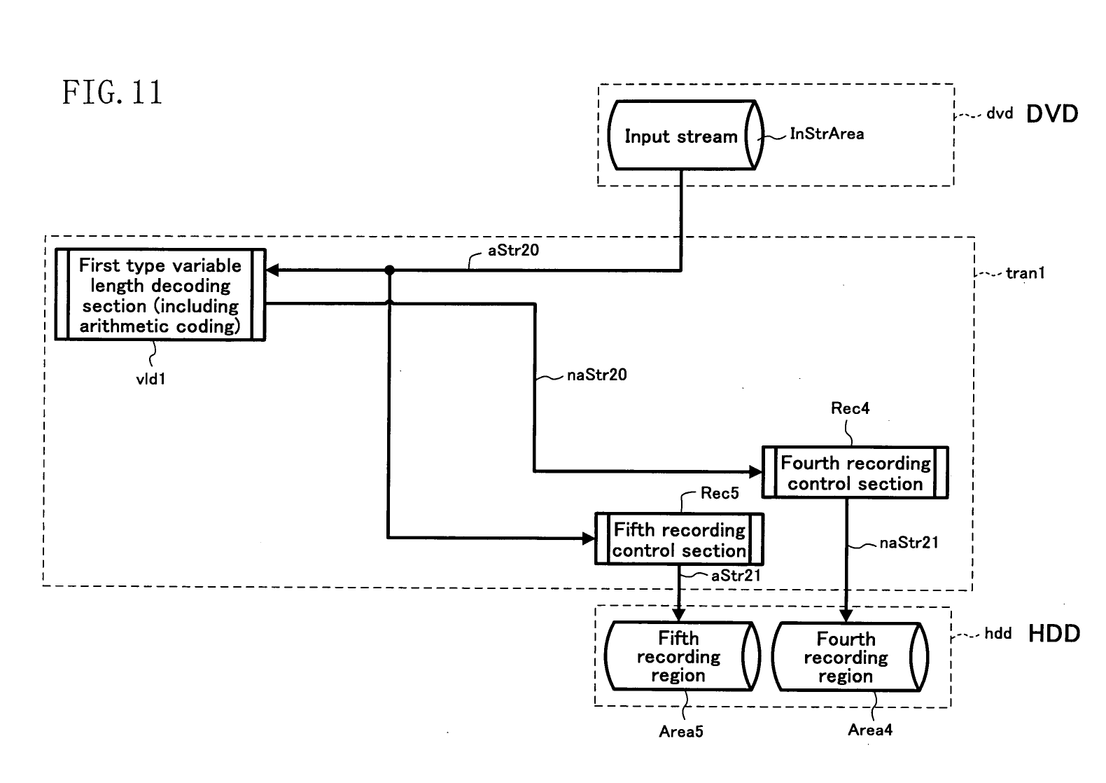

FIG. 11 is a block diagram illustrating a configuration of a transcoder (moving picture encoding/decoding apparatus) from a DVD format to a HDD format.

In FIG. 11, each member also shown in FIG. 2 or FIG. 7 is identified by the same reference numeral and therefore the description thereof will be omitted. In FIG. 11, for simplification, only necessary blocks selected from the configurations of FIG. 2 or FIG. 7 and connected to one another (tran1) are illustrated. Illustration of connection for a stream buffer StrBuf with other components is omitted. In FIG. 11, as a large capacity storage device Disc, two media, i.e., a transfer source DVDdvd including an input stream region InStrArea and a transfer destination HDDhdd including a second recording region Area2 and a third recording region Area3 are connected.

Hereafter, a signal flow of FIG. 11 will be described. First, an arithmetic coded signal 20aStr20 is read from the input stream region InStrArea included in DVDdvd. If the arithmetic coded signal 20aStr20 is a key frame, the arithmetic coded signal 20aStr20 is received by a first type variable length decoding section vld1 and is converted into a non-arithmetic coded signal 20naStr20 and then the non-arithmetic coded signal 20naStr20 is output. Furthermore, the non-arithmetic coded signal 20naStr20 is received by a fourth recording control section Rec4 and is output as a non-arithmetic coded signal 21naStr21 and then the non-arithmetic coded signal 21naStr21 is stored in a fourth recording region Area4 included in HDDhdd. On the other hand, if the arithmetic coded signal 20aStr20 is not a key frame, a fifth recording control section Rec5 outputs the arithmetic coded signal 21aStr21 in a stream format without conversion and the arithmetic coded signal 21aStr21 is recorded in a fifth recording region Area5.

In the above-described flow, signal processing is performed. Thus, copying or moving data as a processed stream with which smooth playback is feasible from a transportable media such as DVDdvd including a normal stream which can have compatibility between competitors' products but is not capable of smooth special playback to a non transportable media such as HDDhdd.

The arithmetic coded signal 20aStr20 has been described as a signal read from a recording medium such as DVDdvd but may be digital stream data received from digital broadcasting.

<Non-Transportable Media to Transportable Media>

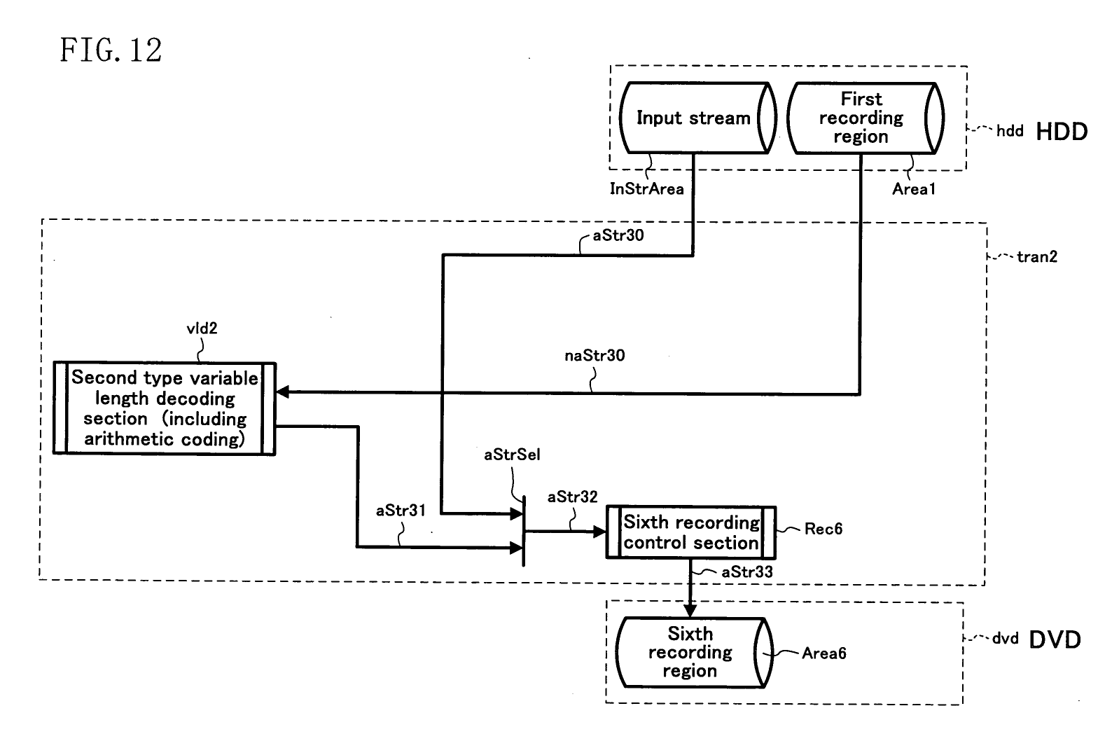

FIG. 12 is a block diagram illustrating a configuration of a transcoder from a HDD format to a DVD format.

In FIG. 12, each member also shown in FIG. 2 or FIG. 7 is identified by the same reference numeral and therefore the description thereof will be omitted. In FIG. 12, for simplification, only necessary blocks selected from the configurations of FIG. 2 or FIG. 7 and connected to one another (tran2) are illustrated. Illustration of connection for a stream buffer StrBuf with other components is omitted. In FIG. 12, as a large capacity storage device Disc, two medium, i.e., a transfer source HDDhdd including an input stream region InStrArea and a first recording region Area1 and a transfer destination DVDdvd including a second recording region Area2 are connected.

Hereafter, a signal flow of FIG. 12 will be described. First, an arithmetic coded signal 30aStr30 including streams other than a key frame is read from an input stream region InStrArea included in HDDhdd and a non-arithmetic coded signal 30naStr30 is read from a first recording region Area1 for storing first type stream data obtained by performing arithmetic coding to a key frame. The non-arithmetic coded signal 30naStr30 is received by a second type variable length decoding section vld2 and the second type variable length decoding section vld2 outputs an arithmetic coded signal 31aStr31.

Next, an arithmetic stream selector aStrSel receives the arithmetic coding signal 30aStr30 and the arithmetic coded signal 31aStr31. In the arithmetic stream selector aStrSel, if the read stream is a key frame, the arithmetic coding signal 30aStr30 is selected, and if the read stream is other than a key frame, the arithmetic coded signal 31aStr31 is selected. Then, the selected signal is output as an arithmetic coded signal aStr32.

Finally, a sixth recording control section Rec6 outputs an arithmetic coded signal 33aStr33 and the arithmetic coded signal 33aStr33 is stored as a formally standardized stream format in a recording region Area6.

In the above-described flow, signal processing is performed. Thus, copying or moving data, from a processed stream of HDDhdd including a stream with which special playback is feasible, as a normal stream which is not capable of smooth special playback but can have compatibility between competitors' products.

### Fourth Embodiment

Subsequently, an application example of the above-described picture encoding/decoding apparatus will be described.

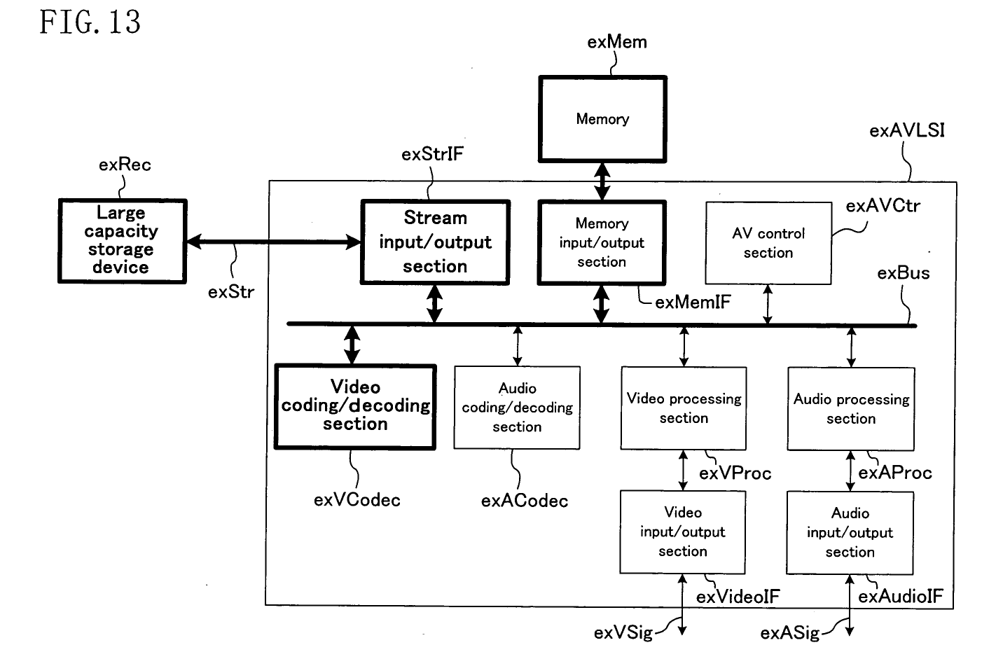

FIG. 13 is a block diagram of an AV processing section implementing a H.264 recorder. In FIG. 13, exAVLSI is an AV processing section such as a DVD recorder, a hard disk recorder and the like for reproducing digital compressed audio and video (picture).

In FIG. 13, exStr denotes stream data of audio and video, exVSig denotes video data and exASig denotes audio data. exBus denotes a bus for transferring data such as stream data, decoded data of audio and video, and the like. exStrIF denotes a stream input/output section for receiving the stream data exStr. On end of the stream input/output section exStrIF is connected to the bus exBus and the other end of the stream input/output section exStrIF is connected to a large capacity storage device exRec. exVCodec denotes a video encoding/decoding section for encoding and decoding a video. The video encoding/decoding section exVCodec is connected to the bus exBus. exMem denotes a memory for storing data such as stream data, coded data, decoded data and the like. The memory exMem is connected to the bus exBus.

In this embodiment, the video encoding/decoding section exVCodec includes the encoding/decoding apparatus of FIG. 1 and FIG. 7. The stream data exStr includes the coded signals Str and IntStr of FIG. 1 and FIG. 7. The memory exMem includes the multi-frame memory FrmMem and the stream buffer StrBuf of FIG. 1 and FIG. 7. The large capacity storage device Disc is included in the large capacity storage device exRec of FIG. 13.

In FIG. 13, exVProc denotes a video processing section for performing pre-processing and post-processing to a video signal. The video processing section exVProc is connected to the bus exBus. exVideoIF denotes a video input/output section for outputting as a video signal exVSig a video data signal which has passed through a video processing section exVProc with or without being processed at the video processing section exVProc to the outside or importing a video signal exVSig from the outside.

Furthermore, exAProc denotes an audio processing section for performing pre-processing and post-processing to an audio signal. The audio processing section exAProc is connected to the bus exBus. exAudioIF denotes an audio input/output section for outputting as an audio signal exASig an audio data signal which has passed through an audio processing section exAProc with or without being processed at the audio processing section exAProc to the outside or importing an audio signal exASig from the outside. exAVCtr denotes an AV control section for performing overall control of an AV processing section exAVLSI.

In encoding, first, the video signal exVSig is received by the video input/output section exVideoIF and the audio signal exASig is received by the audio input/output section exAudioIF.

First, in recording, using the video signal exVSig received by the video input/output section exVideoIF, feature amount extraction for filter processing and encoding and the like are performed in the video processing section exVProc, and the video signal exVSig is stored as an original video in the memory Mem via a memory input/output section exMemIF. Next, original video data and reference video data are transferred from the memory Mem to the video encoding/decoding section exVCodec via the memory input/output section exMemIF again. In the other way around, video stream data and local decompression data coded by the video encoding/decoding section exVCodec are transferred from the video encoding/decoding section exVCodec to the memory exMem.

Using the audio signal exASig received by the audio input/output section exAudioIF, feature amount extraction for filter processing and encoding and the like are performed in the audio processing section exAProc, and the audio signal exASig is stored as original audio data in the memory exMem via the memory input/output section exMemIF. Next, the original audio data is taken out from the memory exMem via the memory input/output section exMemIF again and coded. Then, the coded data is stored again as audio stream data in the memory exMem.

As a final step of encoding, a video stream, an audio stream and other stream information are processed as single stream data and the stream data exStr is output via the stream input/output section exStrIF. Then, write operation of the stream data exStr on the large capacity storage device exRec such as an optical disc (DVD), a hard disk (HDD) and the like is performed.

Next, in decoding, the following operation is performed. First, data stored in the above-described recording is read from the large capacity storage device exRec such as an optical disk, a hard disk, a semiconductor memory or the like. Thus, a stream signal exStr of an audio and a video is received via the stream input/output section exStrIF. Of the stream signal exStr, a video stream is received by the video encoding/decoding section exVCodec and an audio stream is received by an audio encoding/decoding section exACodec.

Video data decoded by the video encoding/decoding section exVCodec is temporarily stored in the memory Mem via the memory input/output section exMemIF. Data stored in the memory Mem is subjected to processing such as noise removal and the like in the video processing section exVProc. There are cases where video data stored in the memory Mem is used as a reference picture for inter-picture motion compensation prediction in the video encoding/decoding section exVCodec again.

Audio data decoded by the audio encoding/decoding section exACdec is temporarily stored in the memory Mem via the memory input/output section exMemIF. Data stored in the memory Mem is subjected to processing such as acoustic processing and the like in the audio processing section exAProc.

Finally, while audio and video are temporally synchronized, data processed in the video processing section exVProc is output as the video signal exVSig via the video input/output section exVideoIF and is displayed on a TV screen or the like. Data processed in the audio processing section exAProc is output as the audio signal exASig via lo the audio input/output section exAudioIF and then is output from a speaker.

### Fifth Embodiment

Furthermore, by recording a program for implementing the moving picture decoding apparatus, a moving picture encoding apparatus and a moving picture encoding/decoding apparatus described in the above-described embodiments by software in a memory media such as a flexible disk or the like, processing described in each of the above-described embodiments can be performed in an independent computer system in a simple manner.

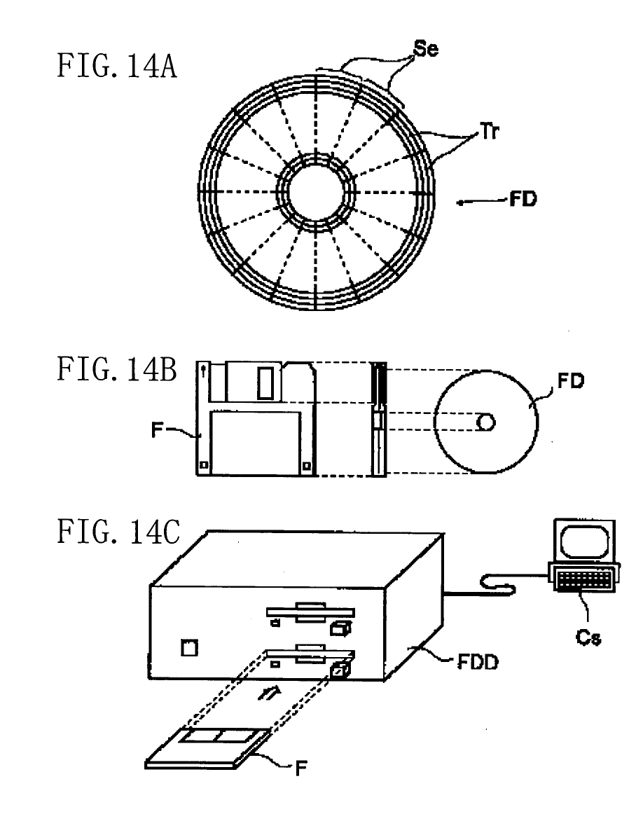

FIGS. 14A through 14C are views for explaining cases where the moving picture decoding apparatus, the moving picture encoding apparatus and the moving picture encoding/decoding apparatus of the first, second, third and fourth embodiments are implemented by a computer system using a flexible disk in which the program realizing the moving picture decoding apparatus, the moving picture encoding apparatus and the moving picture encoding/decoding apparatus is stored.

FIG. 14B shows an outer appearance of a flexible disk when viewed from the front, a cross-sectional structure of the flexible disk and the flexible disk itself. FIG. 14A shows an exemplary physical format of a flexible disk which is a recording media body. A flexible disk FD is embedded in a case F. A plurality of tracks Tr are formed in a surface of the disk so as to be arranged concentrically in the direction from an outer circumference to an inner circumference. Each of the tracks is divided into 16 sectors Se in an angular orientation. Accordingly, in the flexible disk storing the program, a motion compensation apparatus as the program, an inter-picture prediction encoding apparatus using the motion compensation apparatus or an inter-picture prediction decoding apparatus using the motion compensation apparatus is recorded in an allocated region on the flexible disk FD.

FIG. 14C shows a configuration for performing record playback of the program to the flexible disk FD. In recording the program on the flexible disk FD, as the program, a motion compensation apparatus, an inter-picture prediction encoding apparatus using the motion compensation apparatus or an inter-picture prediction decoding apparatus is written from a computer system Cs via a flexible disk drive. Moreover, when the motion compensation apparatus, the inter-picture prediction encoding apparatus using the motion compensation apparatus or the inter-picture prediction decoding apparatus using the motion compensation apparatus is built in a computer system by the program in the flexible disk, the program is read by the flexible disk drive from the flexible disk and transferred to the computer system.

In the description above, the case where a flexible disk is used as a recording media has been shown as an example, but the same operation can be performed using an optical disk. Moreover, a recording media is not limited thereto, the same operation can be performed using an IC card, a ROM cassette and the like in which the program can be recorded.

In the above-described embodiments, processing in which an intermediate stream of a key frame generated during variable length coding or variable length decoding is left and variable length decoding is performed using data from the intermediate stream has been shown. Stream data to be left as an intermediate stream can be stream data obtained using a different variable length coding tool. For example, besides a variable length coding tool using CABAC, the H.264 standard allows a variable length coding tool using CAVLC which does not include arithmetic coding. Therefore, although in the first embodiment, variable length decoding is performed using the first type variable length decoding section vld1 and the second type variable length decoding section vld2, the configuration in which the non-arithmetic coded signal 1naStr1 generated in the first type variable length decoding section vld1 is in a stream format using CAVLC and the second type variable length decoding section vld2 decodes CAVLC can be formed. In the same manner, as an intermediate stream, a stream defined by another standard such as MPEG-2 or a unique stream which does not require sequential processing may be used.

Furthermore, each of function blocks in the block diagrams of FIG. 1, FIG. 2, FIG. 7, FIG. 8, FIG. 11 and FIG. 12 is typically implemented as an LSI which is an integrated circuit. Each function block may be individually provided on a single chip or part or all of each function block may be provided on a single chip (for example, part or a whole of the large capacity storage device Disc in each block diagram may be provided on a single chip). However, a vast amount of data in gigabyte unit has to be stored in each recording region of the large capacity storage device Disc and thus, in general, the large capacity storage device Disc is formed of hard disk, DVD or a memory card. In the same manner, because a large amount of data has to be kept in the stream buffer StrBuf in each block diagram, in general, the stream buffer StrBuf is implemented as a large capacity SDRAM which is externally attachable to an LSI. However, those components might be able to be provided in a single package or on a single chip in future due to future technical improvement.

Moreover, although it has been described that each block is implemented as an LSI, an LSI may be referred to as an IC, a system LSI, a super LSI or an ultra LSI depending on the degree of integration. Also, a technique for implementing an integrated circuit is not limited to the LSI technique, but an integrated circuit may be formed as a circuit for exclusive use or a versatile processor. After fabrication of an LSI, FPGA (Field Programmable Gate Array) which is programmable and a reconfigurable processor in which connection and settings for circuit cells in an LSI can be reconfigured may be used. Furthermore, needless to say, if a new technique for integrated circuits appears as a replacement of the LSI technique due to the progress in semiconductor technology or some other technology derived from the semiconductor technology, each function block may be implemented as an integrated circuit using the new technique. For example, biotechnology and the like might be possibly applied.

What is claimed is:

1. A moving picture decoding apparatus for decoding a moving picture signal including variable length coded data using arithmetic coding, the apparatus comprising:
a first variable length decoding section for performing first type variable length decoding including arithmetic decoding to input stream data to generate first type stream data;
a second type variable length decoding section for performing second type variable length decoding which does not include arithmetic decoding to the first type stream data generated by the first type variable length decoding section to generate output data; and
a first recording control section for selecting only specific data from the first type stream data generated by the first type variable length decoding section to record the specific data in a first recording region.

2. The moving picture decoding apparatus of claim 1, further comprising a selecting section for selecting one of the specific data generated by the first type variable length decoding section and recorded in the first recording region and the first type stream data other than the specific data,
wherein the second type variable length decoding section receives, according to the selecting section, the specific data selected out of the first type stream data from the first recording region and the first type stream data other than the specific data from the first type variable length decoding section.

3. The moving picture decoding apparatus of claim 1, wherein the first recording control section selects data to be used in special playback as the specific data from the first type stream data and records the specific data in the first recording region.

4. The moving picture decoding apparatus of claim 3, wherein the special playback is multiple-fold speed playback or reverse playback, or thumbnail moving picture playback.

5. The moving picture decoding apparatus of claim 1, wherein the specific data selected and recorded by the first recording section is data including a picture which is to be a reference picture to be referred to for some other picture.

6. The moving picture decoding apparatus of claim 1, wherein the first type variable length decoding section utilizes time in which sequential decoding is not performed in normal playback to read ahead the input stream data and generate the first stream.

7. A moving picture encoding apparatus for encoding a moving picture signal including variable length coded data using arithmetic coding, the apparatus comprising:
a first type variable length coding section for performing first type variable length coding which does not include arithmetic coding to input stream data to generate first type stream data;
a second type variable length coding section for performing second type variable length coding including arithmetic coding to the first type stream data generated by the first type variable length coding section to generate second type stream data;
a second recording control section for recording the second type stream data generated by the second type variable length coding section in a second recording region; and
a third recording control section for selecting only specific data from the first type stream data generated by the first type variable length coding section to record the specific data in a third recording region.

8. The moving picture encoding apparatus of claim 7, wherein the third recording control section selects data to be used in special playback as the specific data from the first type stream data and records the specific data in the third recording region.

9. The moving picture encoding apparatus of claim 8, wherein the special playback is multiple-fold speed playback or reverse playback, or thumbnail moving picture playback.

10. The moving picture encoding apparatus of claim 7, wherein the specific data selected and recorded by the third recording control section is data including a picture which is to be a reference picture to be referred to for some other picture.

11. The moving picture encoding apparatus of claim 7, wherein the second recording region in which the second type stream data is recorded in a transportable recording media by the second recording control section exists, and
the third recording control section does not record the specific data in the third recording region.

12. The moving picture encoding apparatus of claim 7, wherein the second recording region in which the second type stream data is recorded in a non-transportable recording media by the second recording control section exists, and the second recording control section does not record the specific data which has been recorded as the first type stream data by the third recording control section in the third recording region as the second type stream data in the second recording region.

13. A moving picture encoding/decoding apparatus for decoding a moving picture signal including variable length coded data using arithmetic coding and then encoding the moving picture signal, the apparatus comprising:
a first type variable length decoding section for performing first type variable length decoding including arithmetic decoding to input stream data to generate first type stream data;
a fourth recording control section for selecting only specific data from the first type stream data generated by the first type variable length decoding section to record the specific data in a fourth recording region; and
a fifth recording control section for recording the input stream data without data conversion in a fifth recording region,
wherein in copying a data stream of a transportable recording media onto a non-transportable recording media, the data stream of the transportable recording media is copied onto the fourth recording region and the fifth recording region in the non-transportable recording media using the fourth recording control section and the fifth recording control section.

14. A moving picture encoding/decoding apparatus for decoding a moving picture signal including variable length coded data using arithmetic coding and then encoding the moving picture signal, the apparatus comprising:
a second variable length coding section for performing second type variable length coding including arithmetic coding to specific stream data which has not been arithmetic coded out of input stream data to generate second type stream data; and
a sixth recording control section for selecting one of the input stream data and the second type stream data generated by the second variable length coding section and recording the selected one as a single stream data in the sixth recording region,
wherein in copying a data stream from a non-transportable recording media onto a transportable recording media, the specific stream data of the input stream data which has not been arithmetic coded is recorded as the second type stream data in a sixth recording region of the transportable recording media.

15. A moving picture decoding method for decoding a moving picture signal including variable length coded data using arithmetic coding, the method comprising:
a first type variable length decoding step of performing first type variable length decoding including arithmetic decoding to input stream data to generate first type stream data;
a second type variable length decoding step of performing second type variable length decoding which does not include arithmetic decoding to the first type stream data generated in the first type variable length decoding step to generate output data; and
a first recording control step of selecting only specific data from the first type stream data generated in the first type variable length decoding step to record the specific data in the first recording region.

16. The method of claim 15, wherein in the second type variable length decoding step, in generating the output data, the specific data out of the first type stream data is received from the first recording region, a data stream generated in the first type variable length decoding step is received as the first type stream data other than the specific data and second type variable length decoding which does not include arithmetic decoding is performed.

17. A moving picture encoding method for encoding a moving picture signal including variable length coded data using arithmetic coding, the method comprising:
a first type variable length coding step of performing first type variable length coding which does not include arithmetic coding to input stream data to generate first type stream data;
a second type variable length coding step of performing second type variable length coding including arithmetic coding to the first type stream data generated in the first type variable length coding step to generate second type stream data;
a second recording control step of recording the second type stream data generated in the second type variable length coding step in a second recording region; and
a third recording control step of selecting only specific data from the first type stream data generated in the first type variable length coding section to record the specific data in a third recording region.

18. The moving picture decoding apparatus of claim 1, wherein each of the first type variable length decoding section, the second type variable length decoding section and the first recording control section is provided as an integrated circuit.

19. The moving picture encoding apparatus of claim 7, wherein each of the first type variable length decoding section, the second type variable length decoding section, the second recording control section and the third recording control section is provided as an integrated circuit.

20. A moving picture decoding program for making a computer execute decoding of a moving picture signal including variable length coded data using arithmetic coding, the program comprising:
a first type variable length decoding step of performing first type variable length coding including arithmetic coding to input stream data to generate first type stream data;
a second type variable length decoding step of performing second type variable length decoding which does not include arithmetic decoding to the first type stream data generated in the first type variable length decoding step to generate output data; and
a first recording control step of selecting only specific data from the first type stream data generated in the first type variable length decoding step to record the specific data in the first recording region.

21. A moving picture encoding program for making a computer execute encoding of a moving picture signal including variable length coded data using arithmetic coding, the program comprising:
a first type variable length coding step of performing first type variable length coding which does not include arithmetic coding to input stream data to generate first type stream data;
a second type variable length coding step of performing second type variable length coding including arithmetic coding to the first type stream data generated in the first type variable length coding step to generate second type stream data;
a second recording control step of recording the second type stream data generated in the second type variable length coding step in a second recording region; and
a third recording control step of selecting only specific data from the first type stream data generated in the first type variable length coding section to record the specific data in a third recording region.
